(19) United States
(12) Patent Application Publication
(10) Pub. No.: US 2022/0251300 A1
(43) Pub. Date: Aug. 11, 2022

(54) BIO-BASED POLYSULFONES AND USES THEREOF

(71) Applicants: Thomas H. EPPS, III, Bear, DE (US); LaShanda T. J. Korley, Middletown, DE (US); Matthew D. Green, Phoenix, AZ (US); Jignesh S. Mahajan, Newark, DE (US); Hoda Shokrollahzadeh Behbahani, Tempe, AZ (US)

(72) Inventors: Thomas H. EPPS, III, Bear, DE (US); LaShanda T. J. Korley, Middletown, DE (US); Matthew D. Green, Phoenix, AZ (US); Jignesh S. Mahajan, Newark, DE (US); Hoda Shokrollahzadeh Behbahani, Tempe, AZ (US)

(73) Assignees: University of Delaware, Newark, DE (US); Arizona Board of Regents on behalf of Arizona State University, Scottsdale, AZ (US)

(21) Appl. No.: 17/616,245

(22) PCT Filed: Jun. 11, 2020
(86) PCT No.: PCT/US20/37332

§ 371 Date: Dec. 3, 2021

Related U.S. Application Data
(60) Provisional application No. 62/859,811, filed on Jun. 11, 2019.

(51) Int. Cl. C08G 75/20; C08L 81/06; B01D 71/68; B01D 61/02; B01D 69/02; C02F 1/44; H01M 8/1004; H01M 8/1032

(52) U.S. Cl. CPC C08G 75/20; C08L 81/06; B01D 71/68; B01D 61/025; B01D 2315/08; C02F 1/441; H01M 8/1004; H01M 8/1032; B01D 2325/02; B01D 69/02

(57) ABSTRACT

Disclosed herein are bio-based polysulfones, and in particular, bisguaiacol-based PSfs synthesized from (i) at least one polymerizable lignin-based monomer having a structure corresponding to formula (I) wherein each R¹ is independently either an H or a methyl group, wherein R², R³, and R⁴ are each individually selected from an H or a methoxy group, and (ii) at least one polymerizable 4,4′-dihalophenyl sulfone as a comonomer. Also, disclosed herein are compositions comprising the bio-based polysulfones and a membrane comprising the composition

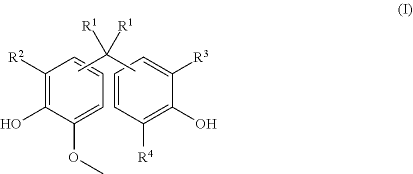

### CROSS-REFERENCE TO RELATED APPLICATION

This application claims priority to U.S. Provisional Patent Application No. 62/859,811 filed Jun. 11, 2019, the entire disclosure of which is incorporated herein by reference for all purposes.

### STATEMENT REGARDING FEDERALLY SPONSORED RESEARCH

This invention was made with government support under Grant No. 1506623 awarded by the National Science Foundation/Division of Materials Research (DMR), Grant No. 1836719 awarded by the National Science Foundation/Division of Chemical, Bioengineering, Environmental and Transport Systems (CBET), Grant No. 1934887 awarded by the National Science Foundation/Civil, Mechanical and Manufacturing Innovation (CMMI) under the Growing Convergence Research program, and Grant No. 80NSSC18K1508 awarded by the National Aeronautics and Space under Early Career Faculty (ECF) program. The government has certain rights in the invention.

### FIELD OF THE INVENTION

The present invention relates to bio-based poly(arylene ether sulfone)s, or polysulfones (PSfs), and methods of making and using such bio-based PSfs in membrane-based applications.

### BACKGROUND OF THE INVENTION

PSfs are a class of high-performance polymers with the highest service temperature of all melt-processable thermoplastics. PSfs are used widely in biomedical, healthcare, and food contact materials because of their relative chemical inertness, hydrolytic stability, mechanical strength, high-temperature stability, biocompatibility, and ease of sterilization. These materials are employed in hemodialysis membranes, and they are a preferred choice for water filtration membranes (e.g., ultrafiltration, nanofiltration, asymmetric reverse osmosis, hollow fiber membranes); and proton-exchange membranes for fuel cells. Although PSfs are excellent candidates for many high-performance applications, they are derived mainly from bisphenol A (BPA), a suspected human endocrine disruptor. Moreover, several commercial alternatives to BPA e.g., tetrachlorobisphenol A and bisphenol B, among others, are not necessarily safer as they can still exhibit some level of endocrine disruption potential. Because of the increasing health concerns associated with exposure to BPA and its commercially available replacements, new compounds with reduced toxicity, increased sustainability, and comparable or better thermomechanical properties are highly desirable

There is a growing interest in using bio-based resources for the development of next-generation materials to reduce reliance on petroleum-based feedstocks. Lignin is the most abundant source of renewable aromatic chemicals and serves as a platform for the development of an array of biobased polymers. Recently, bisguaiacol F (BGF) compounds were reported as potential lignin-derived alternatives to commercial bisphenols for epoxy networks. BGF, however, has a methylene bridge between two aromatic rings, which makes it more structurally similar to bisphenol F (BPF) than BPA.

The lignin-derived compound, bisguaiacol A (BGA)—also referred to as 4,4′(2,2′-isoPropylidene)-Bis(ortho Methoxy) Phenol (PBMP), dimethoxy bisphenol A (DMBPA), guaiacol bisphenol A (G-BPA)—has an isopropylene bridge between two aromatic moieties and closely resembles the structure of BPA and is disclosed in U.S. Pat. No. 9,120,893 B1. Most importantly, lignin-derived bisguaiacols have methoxy substituents in the ortho positions on their aromatic rings in contrast to their commercial petroleum-based analogues. The methoxy groups hinder estrogen binding, which can significantly reduce endocrine disruption potential. Thus, bisguaiacols are potentially safer alternatives to commercial bisphenols. Because of the excellent properties of PSfs (such as chemical inertness, hydrolytic stability, mechanical strength, high-temperature stability, biocompatibility, and ease of sterilization), they are employed widely in membrane applications, such as water treatment (e.g., reverse osmosis desalination, for which PSfs are used as supports for thin-film composites and also as the dense active layer; ultrafiltration; and dialysis). In many applications, water must be able to transport through the PSf membrane. Because commercially available PSfs are made from BPA as monomer, there is concern of residual BPA leaching out of the PSf membrane into the water. Hence, there is a need for bio-based polysulfones based on bisguaiacol compounds with reduced toxicity, increased sustainability, and comparable or better thermomechanical properties in comparison to the polysulfones based on bisphenols.

### SUMMARY OF THE INVENTION

Disclosed herein are bio-based polysulfones, and in particular, bisguaiacol-based PSfs synthesized from renewable bisguaiacols, such as, bisguaiacol F (BGF) and bisguaiacol A (BGA). Also, disclosed herein are the thermal and mechanical behavior of these novel materials in comparison to commercially relevant BPF-based and BPA-based PSfs. Additionally, performance properties (such as water permeation and water uptake) of BGF-based and BGA-based PSfs membranes in comparison to commercial analogues (BPF-based and BPA-based PSfs) are also disclosed.

Bio-based polysulfones in embodiments of the present invention can be utilized in a number of membrane applications because they possess robust thermomechanical properties, stability in some organic solvents, and hydrolytic stability. Several applications require water transport through the membrane, including water treatment (e.g., reverse osmosis desalination, may include bio-based PSfs of the present invention as supports for thin-film composites and also as the dense active layer.

In an aspect of the present invention, there is provided a bio-based polysulfone comprising in polymerized form:
(i) at least one polymerizable lignin-based monomer having a structure corresponding to formula (I):

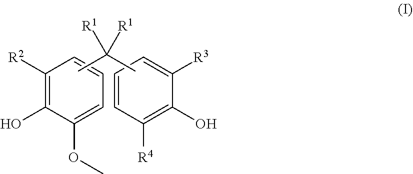

wherein each R¹ is independently either an H or a methyl group,

wherein R², R³, and R⁴ are each individually selected from an H or a methoxy group, and
(ii) at least one polymerizable 4,4′-dihalophenyl sulfone as a comonomer.

In another embodiment of the bio-based polysulfone, the polymerizable lignin-based monomer comprises bisguaiacol A, bisguaiacol F, bisguaiacol-P, bisguaiacol-S, bisguaiacol-M, bisguaiacol-X, their regioisomers, and mixtures thereof.

In an embodiment, the bio-based polysulfone is represented by the formula:

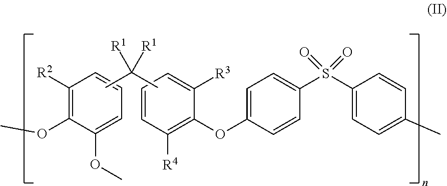

wherein n [degree of polymerization]=2-2000; each R¹ is independently either an H or a methyl group; and R², R³, and R⁴ are each individually selected from an H or a methoxy group.

In yet another embodiment of the bio-based polysulfone, the polymerizable lignin-based monomer comprises a mixture of p,p′-bisguaiacol F, m,p′-bisguaiacol F, and o,p′-bisguaiacol F, such that the resulting bio-based polysulfone is represented by the following structure:

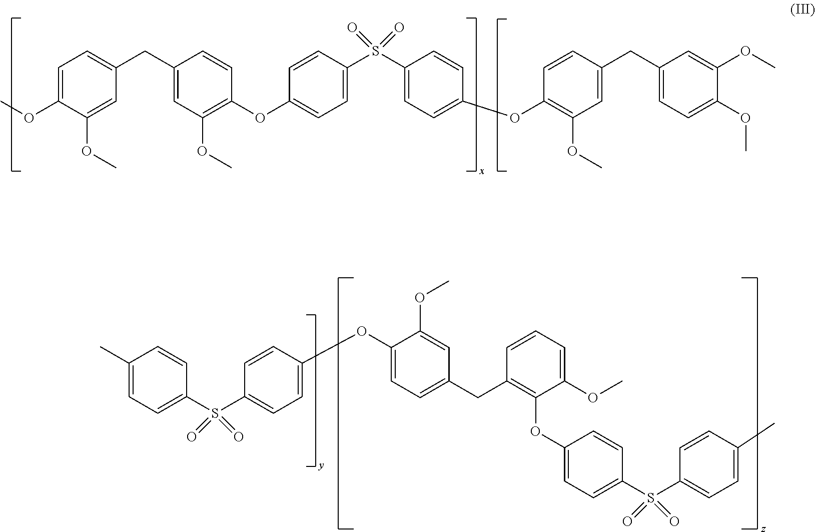

where x+y+z=1, 0<x≤1, 0<y≤1, and 0<z≤1; and where x, y, and z represent the molar fractions of the respective chemical units.

In still another embodiment of the bio-based polysulfone, the polymerizable lignin-based monomer comprises a mixture of p,p′-bisguaiacol A, m,p′-bisguaiacol A, and o,p′-bisguaiacol A, such that the resulting bio-based polysulfone is represented by the following structure:

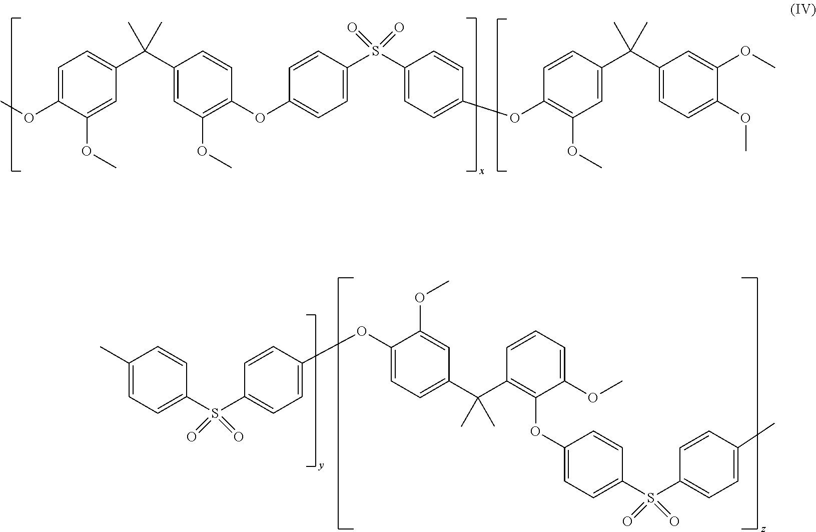

where x+y+z=1, 0<x≤1, 0<y≤1, and 0<z≤1; and where x, y, and z represent the molar fractions of the respective chemical units.

In another embodiment, the polymerizable lignin-based monomer is a mixture of lignin-based monomer and a comonomer. The comonomer may comprise at least one of 2,2′-diallylbisphenol A, bisphenol A, bisphenol F, bisphenol S, 2,2′-biphenol, 4,4′-biphenol, and/or hydroquinone. In an embodiment, the comonomer is 2,2′-diallylbisphenol A and the resulting bio-based polysulfone is represented by the following structure:

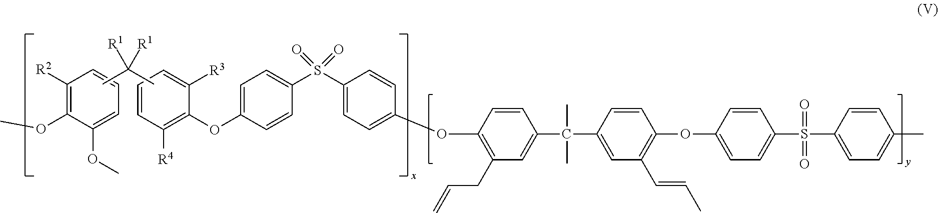

where x+y=1; and 0<x≤1, 0.251, 0<x≤0.25, or 0.25≤y≤0.75; x and y represent the molar fractions of the respective chemical units,

wherein R¹ is either H or methyl group, and

wherein R², R³, and R⁴ are each individually selected from an H or a methoxy group.

In an aspect, the bio-based polysulfone is modified with one or more functional groups selected from sulfonates, carboxylates, ammoniums, amines, alcohols, sulfobetaines, carboxybetaines, 2,2′-diallylbisphenol A and poly(ethylene glycol) (PEG), such that the resulting bio-based polysulfone is represented by the following structure:

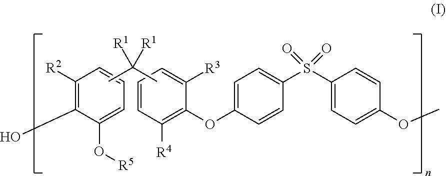

wherein n [degree of polymerization]=2-2000; R¹ is either an H or a methyl group, and R², R³, and R⁴ are each individually selected from an H or a methoxy group or the functionality described as O—R⁵ directly bonded to the phenyl ring, and wherein R⁵ is individually selected from an H, a COOH, an 503H, or an alkyl amine such as, CH₂CH₂CH₂NH₂ and quaternary ammonium and betaine-type zwitterions.

In another aspect, the bio-based polysulfone as disclosed hereinabove is zwitterionic, and wherein the zwitterionic functionality is selected from dimethylammonioacetate (carboxybetaine) groups, dimethylammoniopropyl sulfonate (sulfobetaine) groups, or combinations thereof.

One aspect of the invention relates to a composition comprising the bio-based polysulfone, as disclosed hereinabove. In an embodiment, the composition is a blend comprising one or more of a bio-based PSf homopolymer represented by structures (II)-(IV); a bio-based PSf-co-SBAES copolymer represented by structures (V)-(VI); a BP-based PSf, and a hydrophilic polymer. In another embodiment, the composition further comprises one or more additives selected from the group consisting of tackifiers, plasticizers, viscosity modifiers, photoluminescent agent, anti-counterfeit and UV-reactive additives, dyes/pigments, anti-static materials, surfactants, and lubricants.

In an aspect, there is a membrane comprising the composition disclosed hereinabove. Yet another aspect of the invention includes an article comprising the membrane. The article may be a filtering apparatus, or any membrane comprising the composition without restriction to any particular use.

In an embodiment, the article is a filtering apparatus comprising a reverse osmosis apparatus, a dialysis apparatus, a nanofiltration apparatus, an ultrafiltration apparatus or a microfiltration apparatus. In another embodiment of the filtering apparatus, the membrane is configured to operate in a dead-end filtration mode, a cross-flow filtration mode, or a hollow fiber filtration mode. In an embodiment, the filtering apparatus may comprise a reverse osmosis apparatus, a dialysis apparatus, a nanofiltration apparatus, an ultrafiltration apparatus, or a microfiltration apparatus. In an embodiment, the membrane has a homogeneous pore size in the range from 0.5 nm to 10 μm, selected from the group consisting of: a nanofiltration membrane with a homogeneous pore size in the range of 0.5 to 10 nm; a nanofiltration membrane with a homogeneous pore size in the range of 10 to 100 nm; an ultrafiltration membrane with a homogeneous pore size in the range of 100 nm to 1 μm; and a microfiltration membrane with a homogeneous pore size in the range of 1 to 10 μm. In another embodiment, the membrane is a reverse osmosis membrane having no pores or pores having a size in the range of 0.2-0.5 nm.

Another aspect is a method of purifying water, the method comprising a step of filtering untreated water from a water source through the membrane, as disclosed hereinabove. The method can be applied for water reclamation, wastewater treatment, or water purification.

Yet another aspect includes a membrane electrode assembly, comprising an anode; a cathode; and a proton exchange membrane positioned between the anode and the cathode, wherein the proton exchange membrane and at least one of the anode and the cathode comprises the bio-based polysulfone of the present disclosure modified with an anionic moiety to enable proton exchange.

### BRIEF DESCRIPTION OF THE DRAWINGS

FIG. 1A displays an exemplary scheme for making bio-based polysulfones from phenolic monomers, such as substituted methoxyphenols derived from lignocellulosic biomass, according to an embodiment of the present invention.

FIG. 1B shows (a) reductive catalytic fractionation (RCF) of lignocellulosic biomass (LCB) to solid cellulosics and substituted phenols. The R₁ and R₂ groups are influenced by the type of biomass and processing conditions. (b) BPA alternatives from lignin derivatives, including monoaromatics and coupled compounds.

FIG. 2A displays exemplary schemes for synthesizing (a) isomeric BGA using guaiacol and acetone, and (b) isomeric BGF using guaiacol and vanillyl alcohol.

FIG. 2B displays exemplary schemes for synthesizing isomeric BGA-based PSfs and BGF-based PSfs according to an embodiment of the present invention.

FIG. 2C displays exemplary schemes for synthesizing poly(bisguaiacolmethane ether sulfone) from polycondensation reaction of bisguaiacols and 4,4′-difluorodiphenyl sulfone (DFDPS), in which x, y, and z is the degree of polymerization of p,p′-bisguaiacol-based segments, m,p′-bisguaiacol-based segments, and o,p′-bisguaiacol-based segments, respectively.

FIG. 2D shows an exemplary scheme for synthesizing zwitterionic PAES-co-SBAES copolymers.

FIG. 3 displays a ¹H NMR spectrum of p,p′, m,p′, and o,p′-BGA monomers.

FIG. 4 displays a ¹H NMR spectrum of p,p′, m,p′, and o,p′-BGF monomers.

FIG. 5 displays an exemplary ¹H NMR spectrum of BGA-based PSf in DMSO-d₆ (with TMS as an internal standard) with peak assignments used to determine the ratio of x:y.

FIG. 6 displays an exemplary ¹H NMR spectrum of BGF-based PSf in DMSO-d₆ (with TMS as an internal standard) with peak assignments used to determine the ratio of x:y.

FIGS. 7A and 7B display SEC traces of BGF-based PSf, BGA-based PSf, and BPF-based PSf from the light scattering (LS) detector (FIG. 7A) and the refractive index (RI) detector (FIG. 7B), after the polymerization was carried out for 24 h.

FIG. 8 displays exemplary Differential Scanning calorimetry (DSC) thermograms used to determine the glass transition temperature (Tₐ) for the BG-based PSfs and BP-based PSfs. The cycles shown are the third heat in a heat-cool-heat-cool-heat 5-step process, each heating step went to 230° C. at 10 K/min and each cool step went to −80° C. at 50 K/min.

FIG. 9 displays exemplary Thermogravimetric analysis (TGA) thermograms for BP-based PSfs and the BG-based PSfs. The samples were heated to 30° C. at a rate of 0.5 K/min to purge the sample cell and then the samples were heated to 600° C. at a rate of 10 K/min. The temperature at which the sample lost 5 wt. % is reported as the degradation temperature (T_{D5%}).

FIGS. 10A-10C shows exemplary scanning electron microscopy (SEM) images of the BGF-based PSf membrane cross-sections showing the morphologies of the membrane structure.

FIG. 11 displays exemplary plot of pure water permeation for BGF-based PSf and BGA-based PSf as a function of time. The test was carried out at a pressure of 30 psi and temperature of 25° C. The linear slope of the volume collected over time (mL/s) can be normalized by the membrane surface area (14.6 cm²) to obtain a water flux.

FIG. 12 displays an exemplary article comprising a bio-based membrane configured to provide a high surface area module.

FIG. 13 displays a schematic illustration of typical components removed using different types of filtration (Image from American Membrane Technology Association, http://www.amtaorg.com).

### DETAILED DESCRIPTION OF THE INVENTION

As used herein, the term “poly(arylene ether sulfone)” is used interchangeably with polysulfones and is abbreviated as PSfs.

As used herein, the term “BP-based PSfs” refers to polysulfones that are made from bisphenols (BP) and include polysulfones from various multiphenols, including, but not limited to bisphenol A (BPA), bisphenol F (BPF), biphenol, hydroquinone, etc.

As used herein, the term “BG-based PSfs” refers to polysulfones that are made from bisguaiacols and include polysulfone homopolymers and copolymers synthesized from various bisguaiacols, including, but not limited to, bisguaiacol A (BGA), bisguaiacol F (BGF), bisguaiacol P (BGP), bisguaiacol S (BGS), bisguaiacol M (BGM), bisguaiacol X (BGX), as shown below, and their regioisomers.

As used herein, the term “bio-based polysulfones” is used interchangeably with “lignin-derived PSf,” and “bisguaiacol-based PSf” and refers to a polysulfones that are derived from at least one polymerizable lignin-based monomer.

As used herein, the term “lignin-based monomer” refers to a chemical compound that is at least partially derived from lignin-containing biomass, including, but not limited to, softwoods, lignocellulose biomass, solid wood waste, forest wood waste, lignin rich food waste, energy crops, animal waste, agricultural waste, or lignin residue generated by cellulosic biorefinery or paper pulping industries. Suitable lignin-rich food wastes include, but are not limited to, nutshells, olive seeds, and tomato peels and seeds. Suitable energy crops include, but are not limited to, wheat, corn, soybean, sugarcane, arundo, camelina, carinate, jatropha, miscanthus, sorghum, and switchgrass. As used herein, the term “lignin-based monomer” may be partly derived from petrochemical resources.

Suitable examples of lignin-containing biomass include, for example and without limitation, oak, alder, chestnut, ash, aspen, balsa, beech, birch, boxwood, walnut, laurel, camphor, chestnut, cherry, dogwood, elm, eucalyptus, pear, hickory, ironwood, maple, olive, poplar, sassafras, rosewood, bamboo, coconut, locust, and willow trees, as well as, but not limited to, grasses (e.g., switchgrass, bamboo, straw), cereal crops (e.g., barley, millet, wheat), agricultural residues (e.g., corn stover, bagasse), and lignin-rich food wastes (e.g., nutshells, olive seeds, tomato peels and seeds).

As used herein, the term “lignin-derived bisguaiacols” is used interchangeably with “lignin-derived BPA alternatives,” “lignin-derived BPA analogues,” “lignin-derived BPA equivalents,” and “bio-derived bisguaiacols,” “bio-derived BPA alternatives,” “bio-derived BPA analogues,” “bio-derived BPA equivalents,” and refers to bisguaiacols that are at least partially derived from lignin-containing biomass.

As used herein, the phrase “a bisphenol equivalent of a lignin-derived monomer” is used interchangeably with “a bisphenol analogue of a lignin-derived monomer” and refers in particular to bisphenol having a structure similar to an ortho-alkoxy bisphenol, which is a lignin-derived monomer, except that bisphenol does not include an ortho-methoxy group on each phenyl group, as present in the lignin-derived monomer. For example, as used herein, BPA is equivalent to or analogue of lignin-derived monomer BGA and BPF is equivalent to or analogue of lignin-derived monomer BGF.

BPA

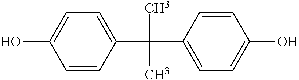 [SMILES: CC(C)(c1ccc(O)cc1)c1ccc(O)cc1]

is equivalent to BGA

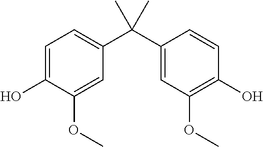 [SMILES: COc1cc(C(C)(C)c2ccc(O)c(OC)c2)ccc1O]

BPF

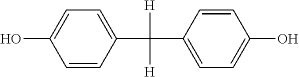 [SMILES: Oc1ccc(Cc2ccc(O)cc2)cc1]

is equivalent to BGF

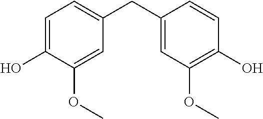 [SMILES: COc1cc(Cc2ccc(O)c(OC)c2)ccc1O]

As used herein, the term “polymerizable bio-based monomer” in the context of the present invention is a bio-based monomer having a moiety containing at least one polymerizable functionality. The polymerizable functionality, in certain embodiments of the invention, is polymerizable through step-growth polymerization, otherwise referred to as polycondensation polymerization.

Disclosed herein are bio-based PSfs, methods of making them, compositions comprising bio-based PSfs, and articles comprising such compositions. Also, disclosed herein are the thermal and mechanical behavior of these novel bio-based PSf in comparison to commercially relevant BPA-based PSfs and BPF-based PSfs.

Also, disclosed herein are lignin-derived bisguaiacols, which have methoxy substituents in the ortho positions on their aromatic rings in contrast to their petroleum-based analogues. Without wishing to be bound by any particular theory, it is believed that the methoxy groups hinder estrogen binding, which can significantly reduce endocrine disruption potential. Thus, bisguaiacols are believed to be potentially safer alternatives to commercial bisphenols.

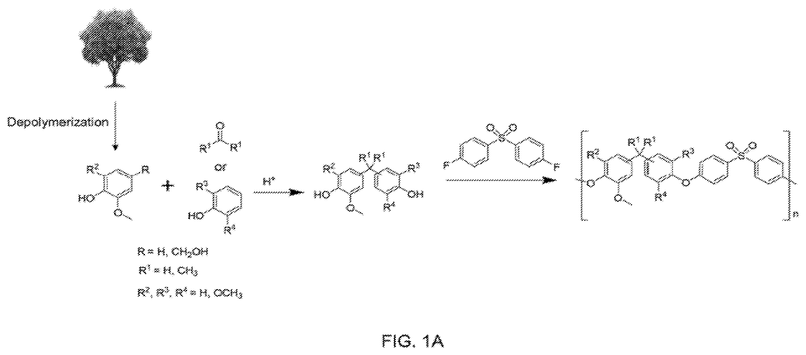

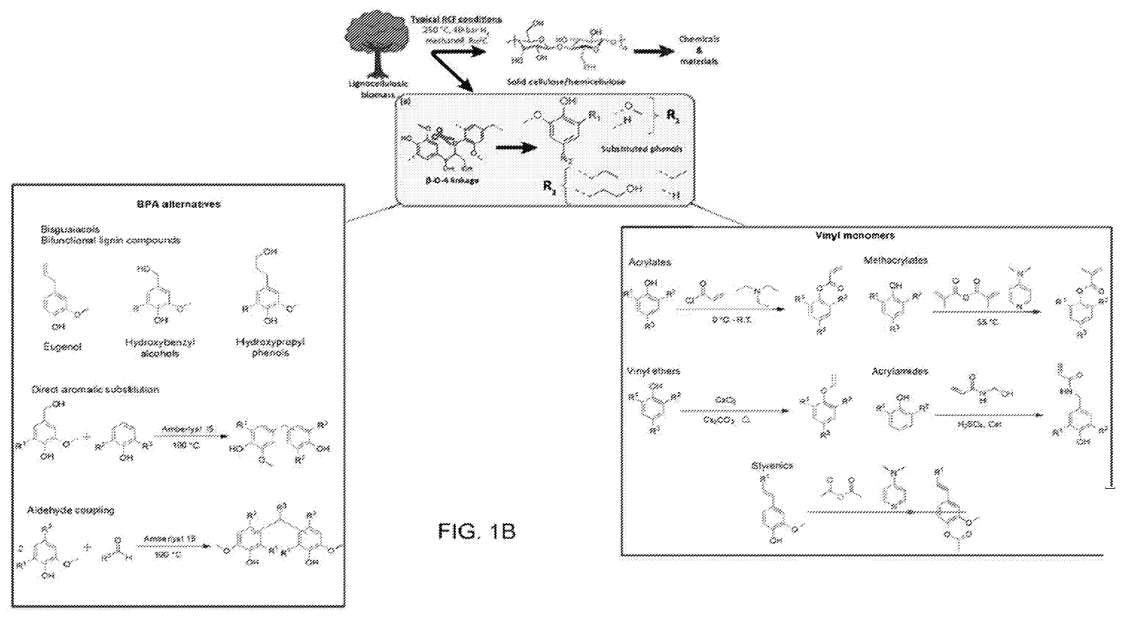

Lignin-derived alternatives to BPA have been produced through a number of approaches, including direct modification of bifunctional compounds, aromatic substitution, aldehyde condensation, and imination, among others. Several examples are shown in FIG. 1B. The simplest BPA alternatives are bifunctional lignin molecules that can be used directly (i.e., without coupling). Vanillyl alcohol and eugenol only contain a single aromatic ring per molecular unit, whereas the more rigid BPA analogues (described below) have two in close proximity. BPA alternatives in which lignin-derived “single-aromatic” molecules are coupled often result in improved thermomechanical properties and offer numerous options to fine-tune structure/function through linker and precursor choice. For example, the direct condensation of substituted hydroxybenzyl alcohols and substituted phenols may yield several bisguaiacols (BGs) with varying o-methoxy contents (FIG. 1B).

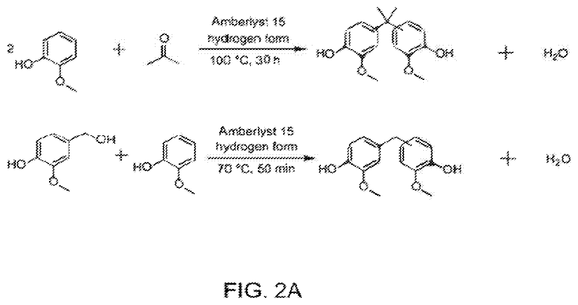

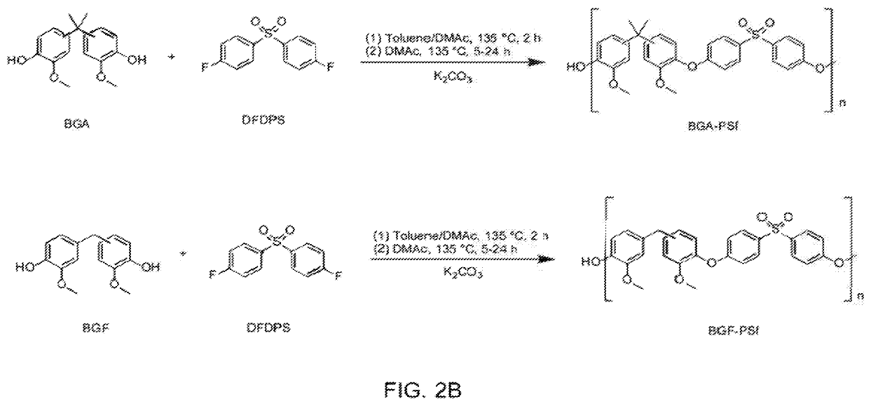

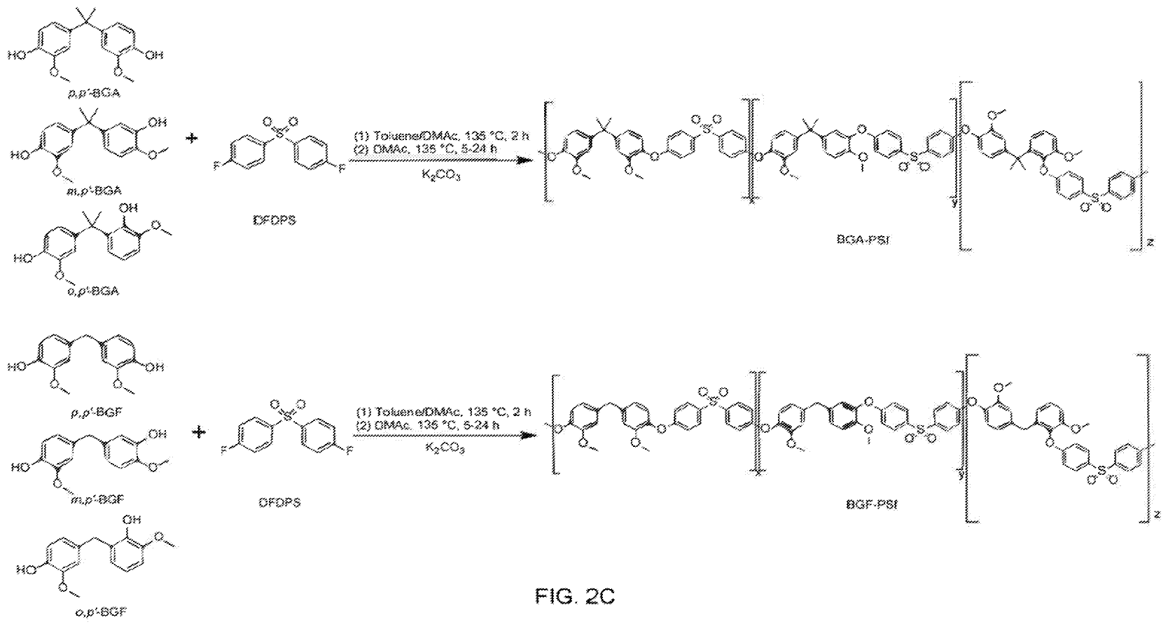

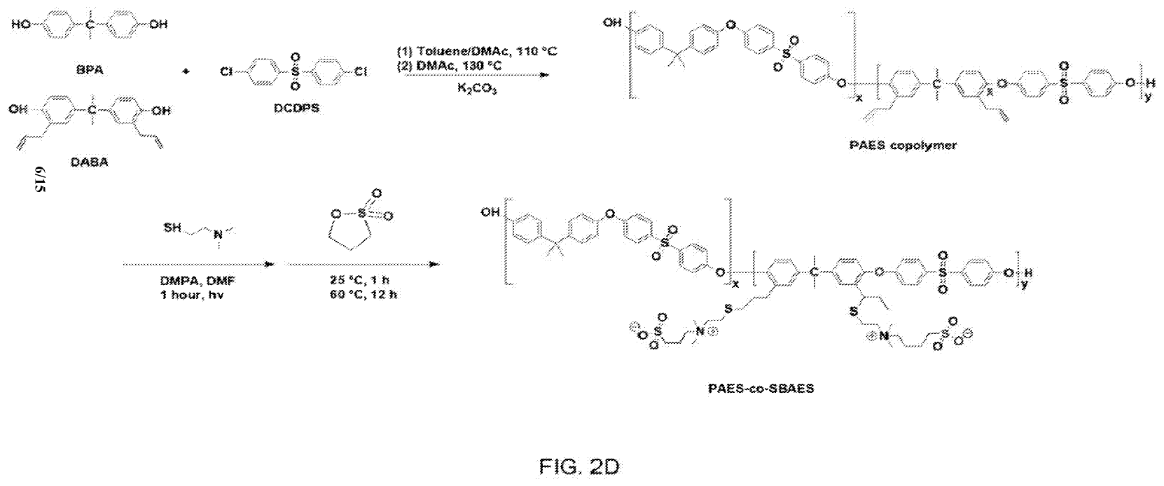

An example of a lignin-derived compound, suitable for use in the synthesis of bio-based polysulfones of the present disclosure is BGA—also referred to as PBMP, G-BPA, and DMBPA—has an isopropylene bridge between two aromatic moieties and closely resembles the structure of BPA and is disclosed in U.S. Pat. No. 9,120,893 B1. In an embodiment of the present invention, BGA can be synthesized via the electrophilic aromatic condensation of guaiacol and acetone in the presence of an acid catalyst, as shown in FIG. 2A(a). Any suitable acid catalyst may be used including, but not limited to, acidic ion exchange resins, hydrochloric acid, sulfuric acid, humin-derived acidic catalyst, and solid and recyclable acid catalyst, such as Amberlyst 15 hydrogen form (dry). The reaction may be conducted in a large excess of guaiacol to minimize the formation of by-products from the self-condensation of acetone. The availability of bio-based acetone along with recyclable catalyst makes for a potentially greener process relative to BPA synthesis. Similarly, BGF may be synthesized from guaiacol and vanillyl alcohol, as shown in FIG. 2A(b), and the direct condensation approach eliminates the use of hazardous formaldehyde inherent in BPF production. The detailed bisguaiacol synthesis and purification procedures are described hereinbelow in the Example section, such as in Example Nos. 1-2.

In an aspect, there is a bio-based polysulfone comprising in polymerized form:
(i) at least one polymerizable lignin-based monomer represented by formula (I):

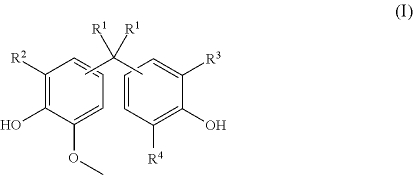

wherein each R¹ is independently either an H or a methyl group,
wherein R², R³, and R⁴ are each individually selected from an H or a methoxy group, and
(ii) at least one polymerizable 4,4′-dihalophenyl sulfone as a comonomer.

Suitable polymerizable lignin-based monomers includes, but are not limited to, BGP, BGF, BGS, BGM, BGA, BGX, as shown below, their regioisomers, and mixtures thereof. In particular, various bisguaiacols represented by formula (I) have following substituents:
1. BGP: R¹ ═H; and R², R³, R⁴ ═H
2. BGF: R¹, R², R³═H; and R⁴═OCH₃
3. BGS: R¹, R²═H; and R³, R⁴═OCH₃
4. BGM: R¹═H; and R², R³, R⁴═OCH₃
5. BGA: R¹═CH₃; R², R³═H; and R⁴═OCH₃
6. BGX: R¹═CH₃; R², R³, R⁴=OCH₃

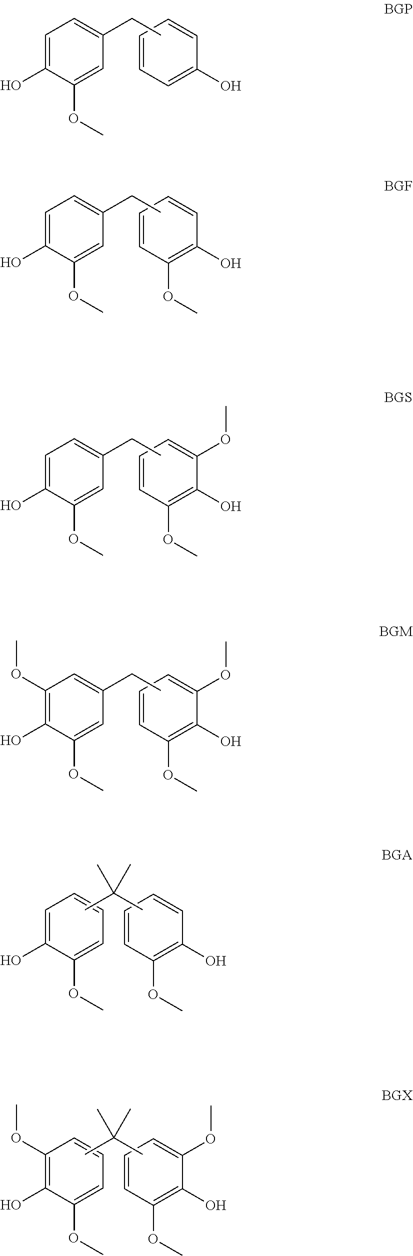

In an embodiment, the bio-based polysulfone as disclosed herein above may be represented by the formula, as shown below:

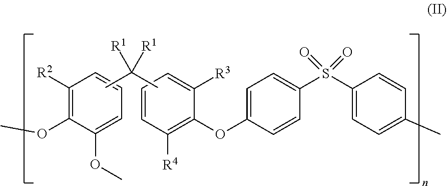

where n [degree of polymerization]=1 to 2000,

where each R¹ is independently either an H or a methyl group; and R², R³, and R⁴ are each individually selected from an H or a methoxy group.

Bio-based polysulfones in accordance with the present invention are not particularly limited with respect to their molecular weights or their geometry. For example, the bio-based polysulfone may be either relatively low in molecular weight (oligomeric) or relatively high in molecular weight. The degree of polymerization, as represented by n may be at least 1, 2, 5, 10, 15, 20, 25, 30, 40, 45, 50, 75, 100, 150, 200, 150, 300, 350, 500, or 750, 900 or 1000, or 1500, 1800, 1900, or 2000 and at most 2000, 1900, 1800, 1500, 1000, 900, 750, 500, 350, 300, 150, 100, 75, 60, 50, 45, 40, 30, 25, 20, 15, 10, 5, or 2. The number average molecular weight of the bio-based polysulfone may range from about 0.1 kDa to about 1000 kDa or 1 kDa to 500 kDa or 5 kDa to 100 kDa or 15 kDa to 50 kDa. The number average molecular weight of the bio-based polysulfone may range from about 30-40 kDa. In an embodiment, the dispersity of the bio-based copolymer may be relatively low (e.g., less than 1.5, for example) or relatively high (e.g., 1.5 or greater). In an embodiment, the dispersity of the bio-based copolymer is around 2.0. The bio-based polysulfone may be, for example, linear, branched or even cross-linked in structure, depending upon the polymerization conditions, initiators, and monomers/comomomers used. The bio-based polysulfone may be a bio-based block copolymer, a random (statistical) bio-based copolymer, a graft bio-based copolymer, a brush bio-based copolymer, a star bio-based copolymer, or the like.

In an embodiment of the bio-based polysulfone of the present invention, the polymerizable lignin-based monomer comprises a mixture of regioisomers, such as p,p′-bisguaiacol F, m,p′-bisguaiacol F, and o,p′-bisguaiacol F, and wherein the resulting bio-based polysulfone is represented by the following structure:

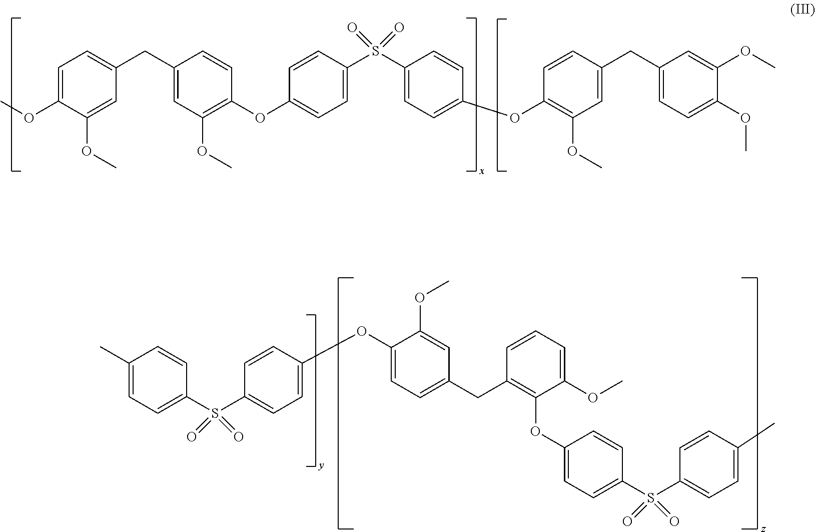

where x, y, and z represent the molar fractions of the respective chemical units and each can be 0 and 1, such that x+y+z=1. In an embodiment 0<x≤1, or 0.25≤x≤1, or 0<x≤0.25, or 0.25≤x≤0.75; and 0<y≤1, or 0.25≤y≤1, or 0<y≤0.25, or 0.25≤y≤0.75; and z=1−x−y.

In another embodiment of the bio-based polysulfone of the present invention, the polymerizable lignin-based monomer comprises a mixture of p,p′-bisguaiacol A, m,p′-bisguaiacol A, and o,p′-bisguaiacol A, and wherein the resulting bio-based polysulfone is represented is represented by the following structure:

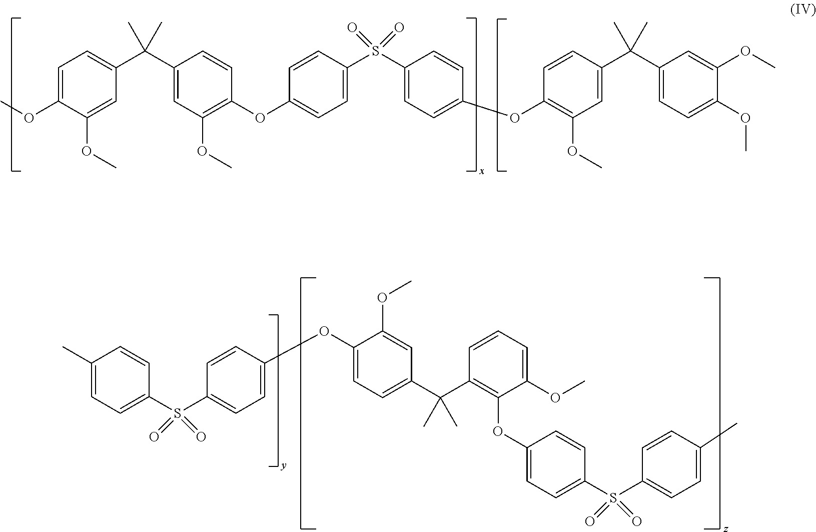

where x, y, and z represent the molar fractions of the respective chemical units and each can be 0 and 1, such that x+y+z=1. In an embodiment 0<x≤1, or 0.25≤x≤1, or 0<x≤0.25, or 0.25≤x≤0.75; and 0<y≤1, or 0.25≤y≤1, or 0<y≤0.25, or 0.25≤y≤0.75; and z=1−x−y.

In an embodiment of the bio-based polysulfone, the polymerizable lignin-based monomer is a mixture of lignin-based monomer and a comonomer. Any suitable comonomers may be added to tune one or more properties of the resulting polysulfone, such as, thermal, mechanical, solvent resistance, etc. properties. In an embodiment, the comonomer is a multiphenol. In yet another embodiment, the comonomer is a phenol equivalent of the lignin-based monomer, including, but not limited to, bisphenol A and bisphenol F. Suitable examples of the comonomers include, but are not limited to, biphenol, hydroquinone, bisphenol A, bisphenol F, bisphenol S, 4,4′-biphenol, 2,2′-biphenol, and 2,2′-diallylbisphenol A. The molar ratios of the lignin-based monomer and the comonomer can vary substantially. In an embodiment, the molar fraction of the lignin-based monomer relative to its bisphenol equivalent, is in the range of 1.0 to 0.001, or 0.95 to 0.05, or 0.90 to 0.10. In another embodiment, the molar fraction of the lignin-based monomer relative to the comonomer is in the range of 1.0 to 0.001, or 0.95 to 0.05, or 0.90 to 0.10.

In an embodiment of the bio-based polysulfone, the polymerizable lignin-based monomer is a mixture of a lignin-based monomer and 2,2′-diallylbisphenol A as a polymerizable comonomer, and wherein the resulting bio-based polysulfone is represented by the following structure:

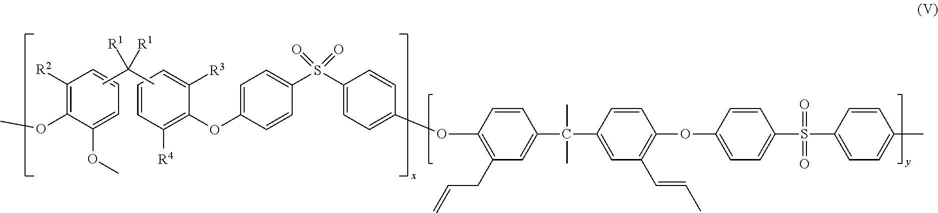

where x and y represent the molar fractions of the respective chemical units, where x+y=1; and 0<x≤1, or 0.25≤x≤1, or 0<x≤0.25, or 0.25≤x≤0.75,

where R¹ is either H or methyl group, and

where R², R³, and R⁴ are each individually selected from an H or a methoxy group.

It should be noted in polysulfone of structure (V) that the double bond of the diallylbisphenol A can undergo thermal rearrangement during polymerization, such that the resulting polysulfone has a mixture of double bonds: internal (C1-C2 of the allyl group) versus at the end of the pendant chain (C2-C3 of the allyl group).

In yet another embodiment, the bio-based polysulfones of the present invention, such as those as represented by structures (II)-(V), are modified with one or more functional groups selected from sulfonates, carboxylates, ammoniums, amines, alcohols, sulfobetaines, carboxybetaines, 2,2′-diallylbisphenol A and poly(ethylene glycol) (PEG). Any suitable method can be used to functionalize, such as by deprotection of the methoxy group and then reacting with the resulting phenol. For example, treating the methoxy groups with a strong base and oxidizing agent, such as sodium hydroxide (NaOH) and potassium permanganate (KMnO₄), can be used to convert the methoxy group to a carboxylic acid.

In yet another embodiment, the added functional groups, e.g., amine, carboxylate, and the like may be used to introduce graft copolymers and other pendant functional groups or polymers.

In an embodiment of the present invention, the bio-based polysulfone is zwitterionic. A zwitterionic bio-based polysulfone can be formed when the comonomer is an allyl-containing monomer. One such suitable, but non-limiting, example of a comonomer having pendant allyl groups is 2,2′-diallylbisphenol A (DABA). The bio-based polysulfones with pendant allyl groups can be functionalized after the polymerization (i.e., with zwitterions) and the concentration of allyl functionality can be tailored by varying the comonomer ratio with respect to the lignin-based monomer, such as DABA/bisguaiacol. Any suitable zwitterions can be used, including, but not limited to, a dimethylammonioacetate (carboxybetaine) group, a dimethylammoniopropyl sulfonate (sulfobetaine) group and combinations thereof.

In one aspect, the bio-based polysulfones of the present invention are synthesized via step-growth polymerization at temperatures below the standard conditions for PSf synthesis in order to reduce the isomerization of allyl groups and other side-reactions (e.g., regioisomers can form on the PAES copolymer).

In an embodiment of the bio-based polysulfone, the zwitterionic moiety is sulfobetaine and the resulting bio-based polysulfone is represented by the following structure:

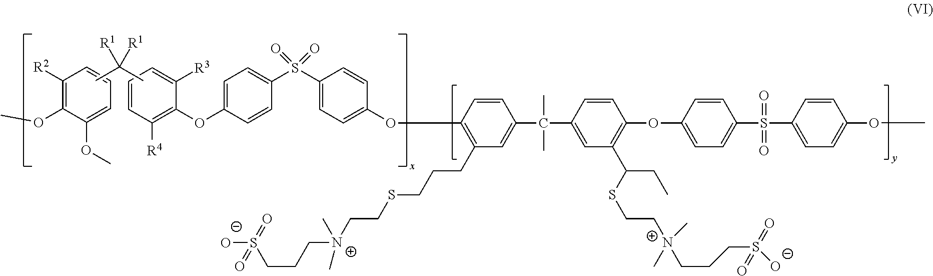

where x+y=1; and 0<x≤1, 0.25x≤1, 0<x≤0.25, or 0.25≤x≤0.75; x and y represent the molar fractions of the respective chemical units.

The bio-based polysulfones may include about 1 wt. % to about 20 wt. %, or about 1.5 wt. % to about 15 wt. %, or about 2 wt. % to about 10 wt. % of the zwitterionic component, such as the zwitterionic poly(sulfobetaine arylene ether sulfone) (SBAES) component in formula (VI), the amounts in wt. % are based on the total weight of bio-based polysulfone.

Any suitable method can be used to synthesize the bio-based polysulfones (both homopolymer and copolymer), such as by a thiol-ene “click” reaction, as shown in FIGS. 2B and 2C. In particular, at least one polymerizable lignin-based monomer having a structure corresponding to formula (I) is reacted with at least one polymerizable 4,4′-dihalophenyl sulfone and optionally with a comonomer such as bisphenol with pendant allyl groups or a bisguaiacol with a pendant allyl group in the presence of a base in a suitable solvent. Any suitable base may be used, including, but not limited to, potassium carbonate. Any suitable solvent may be used, including, but not limited to toluene, dimethyl sulfoxide (DMSO), dimethylacetamide (DMAc), dimethylformamide (DMF) and combinations thereof.

The dihalodiphenyl sulfone may include difluorodiphenyl sulfone, dichlorodiphenyl sulfone, or a combination thereof. After polymerization, the bio-based polysulfone dissolved in a suitable solvent such as DMF and reacted with 2-(Dimethylamino)ethanethiol in the presence of 2,2-dimethoxy-2-phenylacetophenone (DMPA) and ultraviolet light; subsequently, the intermediate tertiary amine-based PSf is reacted with 1,3-propane sultone to yield a zwitterionic bio-based polysulfone. The molar ratio of bisguaiacol, to the bisphenol with pendant allyl groups, biphenol with pendant allyl groups, or combination thereof (e.g., DABA), may be selected to yield the desired amount of zwitterionic poly(sulfobetaine arylene ether sulfone) (SBAES) component of the PSf, which may range from >0 mol % to 100 mol %, or upto 99.9 mole %, or upto 95 mol %, or upto 90 mol %, or upto 75 mol %, or upto. 50 mol %.

In particular, copolymers containing a relatively hydrophobic bio-based poly(arylene ether sulfone) (bio-based PAES) backbone (where bio-based PAES is a BG-based PSf) and hydrophilic sulfobetaine side chains can be synthesized by step growth polymerization and post-polymerization modifications, as described below in Example 4. The backbone structure of the bio-based PAES has high glass transition temperature, significantly above room temperature (>200° C. for high molecular weights), strong mechanical properties, and chlorine resistance and can be further tuned for attaining desired properties by appropriately choosing a monomer from suitable bisgauaicols and bisphenols, as disclosed hereinabove. In an exemplary embodiment, sulfobetaine can be chosen as the functional group to attach to the bio-based PAES backbone through post-polymerization modifications due to its hydrophilicity and demonstrated anti-fouling performance in membrane applications.

Additionally, free standing membranes may be obtained (due to the T_{g} and modulus of bio-based PAES-based polymers) that are compatible and miscible with a BP-based PSf matrix or a BP-based PSf matrix in order to prepare blended membranes with tunable charge content.

In an exemplary embodiment of the present invention, an allyl-modified bio-based PAES copolymer may be prepared by introducing BGA and DCDPS in the presence of potassium carbonate in toluene/DMAc, as well as an allyl-containing monomer, DABA, as shown in FIG. 2D for BP-based PAES-co-SBAES. In this way, the bio-based PAES copolymers with pendant allyl groups can be functionalized after the polymerization (i.e., with zwitterions) and the concentration of allyl functionality can be tailored by varying the monomer ratio of DABA/BPA. In an embodiment of the present invention, the polymers may be synthesized via step-growth polymerization at temperatures below the standard conditions for PSf synthesis in order to reduce the isomerization of allyl groups and other side-reactions (e.g., regioisomers can form on the PAES copolymer).

In an aspect, there is a composition comprising the bio-based polysulfone, as disclosed hereinabove. The composition may further include one or more additives selected from the group consisting of tackifiers, plasticizers, viscosity modifiers, photoluminescent agent, anti-counterfeit and UV-reactive additives, dyes/pigments, anti-static materials, surfactants, and lubricants.

In an embodiment, the composition is a blend of one or more bio-based PSf homopolymers, such as those represented by structures (II)-(IV).

In an embodiment, the composition is a blend of a bio-based PSf-co-SBAES copolymer, such as those represented by structures (V)-(VI) and one or more bio-based PSf homopolymers, such as those represented by structures (II)-(IV).

In another embodiment, the composition is a blend of one or more bio-based PSf homopolymers, such as those represented by structures (II)-(IV) and a BP-based PSf, including, but not limited to BPA-based PSf, BPF-based PSf, biphenol-based PSf, multiphenol-based PSf, and hydroquinone-based PSf, and the like.

In an embodiment, the composition is a blend of a bio-based PSf-co-SBAES copolymer, such as that represented by structures (V)-(VI), one or more bio-based PSf homopolymer, such as those represented by structures (II)-(IV), and a BP-based PSf, including, but not limited to BPA-based PSf, BPF-based PSf, biphenol-based PSf, multiphenol-based PSf, and hydroquinone-based PSf, and the like.

In yet another embodiment, the composition is a blend of one or more bio-based PSf homopolymers and a hydrophilic polymer such as poly(ethylene glycol) (PEG).

The bio-based PSf may be present in the composition in any suitable amount, such as in the range of 0.001-100 wt. %, based on the total weight of the composition. In an embodiment of the composition, the bio-based PSf may be present in an amount of greater than 99 wt. %, 95 wt. %, 90 wt. %, 85 wt. %, 80 wt. %, 75 wt. %, 70 wt. %, 65 wt. %, 60 wt. %, 55 wt. %, 50 wt. %, 45 wt. %, 40 wt. %, 35 wt. %, 30 wt. %, 25 wt. %, 20 wt. %, 15 wt. % or 10 wt. % or 5 wt. % along with a less than 1 wt. %, 5 wt. %, 10 wt. %, 15 wt. %, 20 wt. %, 25 wt. %, 30 wt. %, 35 wt. %, 40 wt. %, 45 wt. %, 50 wt. %, 55 wt. %, 60 wt. %, 65 wt. %, 70 wt. %, 75 wt. %, 80 wt. %, 85 wt. % or 90 wt. % or 95 wt. % of a blend polymer other than the bio-based PSf, as disclosed hereinabove, wherein the amounts the based on the total weight of the composition. In yet another embodiment, the composition comprises a blend of 95-99 wt. % of one or more bio-based PSf present and 1-5 wt. % of a blend polymer other than the bio-based PSf. The composition may also include an additive in an amount of less than 10 wt. %, or less than 5 wt. % or less than 1 wt. %, based on the total weight of the composition.

In an aspect, there is an article comprising the composition as disclosed hereinabove. In an embodiment, the article is a water treatment system. In another embodiment, the article is a biomedical device, such as heart valve holder, or a hemodialysis membrane. In yet another embodiment, the article is a household product, such as plumbing fitting, printed circuit board, food package, etc. In another embodiment, the article is a fuel cell membrane. In an embodiment, the article is a visor for a fire helmet. In one embodiment, the article is an automation component.

In another aspect, the article comprises a membrane formed from the composition, as disclosed hereinabove, comprising the bio-based polysulfone of the present disclosure.

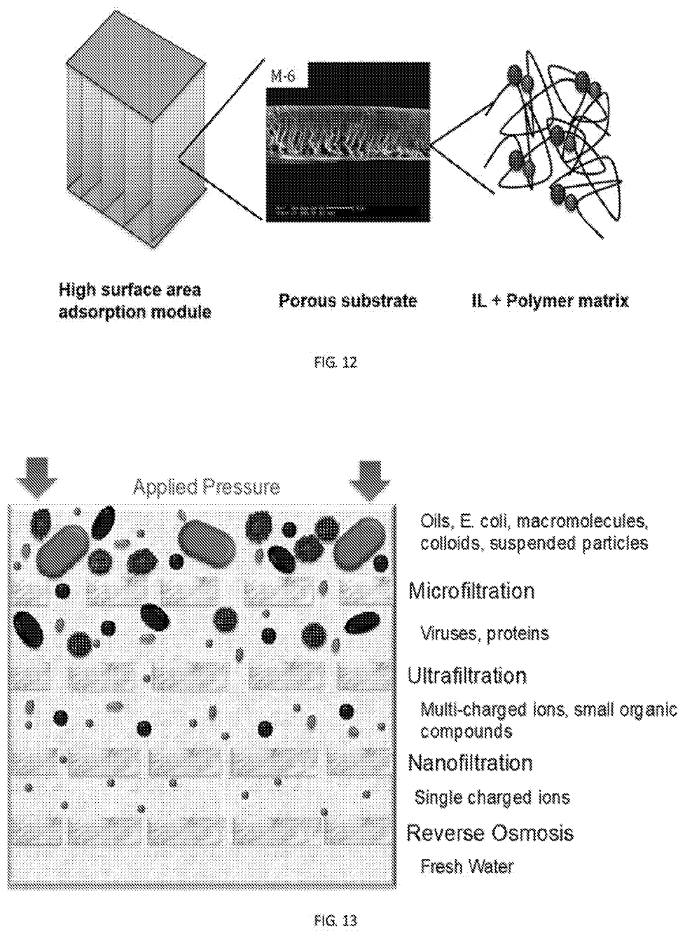

In another embodiment, the article is a filtering apparatus having a filter comprising the membrane as disclosed hereinabove, and where the filtering apparatus is used for reverse osmosis, dialysis, nanofiltration, ultrafiltration, and microfiltration. FIG. 12 shows an exemplary article comprising a bio-based membrane configured to provide a high surface area module. In an embodiment, the article is a high surface area adsorption module configured to capture ionic liquids and/or CO₂. In an embodiment, article comprising bio-based membranes configured to provide a high surface area is configured as a filter of a filtration apparatus. The membrane may be free standing (i.e., without a mechanical support) or supported by a porous substrate, such as a woven or non-woven fabric support, a porous polymer, a porous ceramic, a stainless steel grid, or similar support for the polymer membrane.

In an embodiment, the membrane with a homogeneous pore size in the range from 10 nm to 10 μm, is selected from the group consisting of:
(i) a nanofiltration membrane with a homogeneous pore size in the range of 0.5 to 10 nm;
(ii) a nanofiltration membrane with a homogeneous pore size in the range of 10 to 100 nm;
(iii) an ultrafiltration membrane with a homogeneous pore size in the range of 100 nm to 1 μm; and
(iv) a microfiltration membrane with a homogeneous pore size in the range of 1 μm to 10 μm.

In an aspect, there is a filtering apparatus in accordance with the present disclosure, where the membrane is configured to operate in a dead-end filtration mode, a cross-flow filtration mode, or a hollow fiber filtration mode. In an embodiment, the filtering apparatus may comprise a reverse osmosis apparatus, a dialysis apparatus, a nanofiltration apparatus, an ultrafiltration apparatus, or a microfiltration apparatus

In an embodiment of the filtering apparatus, the membrane is a reverse osmosis membrane having no pores or pores having a size in the range of 0.2-0.5 nm.

In an embodiment, membranes formed from the blended composition, as disclosed hereinabove, comprising a bio-based PSf-co-SBAES copolymer and a bio-based PSf homopolymer, may be prepared by a controlled phase inversion process. The two polymers are dissolved in a solvent such as THF, deposited on a glass plate, or other inert substrate, using a doctor blade (i.e., draw down blade, draw down bar, flow coater, etc.), partially evaporated in air, and then immersed in a coagulation bath containing deionized water to prepare asymmetric membranes (i.e., the non-solvent-induced phase separation (NIPS) process, also called solvent-non-solvent-induced phase separation (SNIPS)).

The morphology of the blended membranes as a function of zwitterion content in the blend polymers of a control blend formed only of BP-based PSf was studied by taking images of the cross-sectional structures of the pristine PSf (M-0) and blend membranes with varying SBAES contents using scanning electron microscopy (SEM) and is disclosed in US Publication No. 2019/0300653 (hereinafter '653) and Yang et al., “Zwitterionic polyarylene ether sulfone) copolymer/poly(arylene ether sulfone) blends for fouling-resistant desalination membranes, J. Membrane Science, 561, (2019), 62-78 (hereinafter “Yang et al.”, disclosures which are incorporated by reference in their entireties for all purposes. Yang et al. showed an exemplary cross-sectional SEM images of pristine PSf asymmetric membranes (0 wt. % zwitterion content, or M-0) and zwitterionic blend membranes with 2 wt. %, 4 wt. %, and 6 wt. % zwitterion (SBAES) content (M-2, M-4, M-6, respectively). M-0 shows a thick dense layer around 2 μm and randomly dispersed macro-pores underneath, while all the blend membranes display a skin-layer on the top surface with thickness around 100 nm and a sponge/finger-like porous sub-layer with thickness around 15 μm. Analysis focused on the observed density and thickness of the selective layer (formed during solvent evaporation) and the porous support structure beneath (formed following immersion in the coagulation bath). The pristine PSf membrane M-0 displayed a thick dense layer around 2 μm and few random macro-pores under the top dense layer, which can be attributed to the instantaneous demixing that occurs in the phase inversion process. All of the blend membranes showed typical asymmetrical structures, consisting of a dense skin-layer on the top surface with a thickness around 100 nm and a porous sub-layer with a thickness around 15 μm. Sponge-like micro-porous structures were observed in all blend membranes, while the finger-like porous structures in the cross-section became more visible and both macro-pore size and micro-pore size became larger with the increasing zwitterion content in blend membranes. In addition, a noticeable decrease in the dense layer thickness above the porous support layer was observed after the incorporation of the zwitterion-functionalized copolymer. This may be attributed at least in part to 1) a reduced THF vapor pressure in the polar, hydrophilic blend solutions, thus limiting the rate of evaporation when the film is exposed to a dry atmosphere, and 2) a reduced viscosity of the blend solution that expedited the solvent/non-solvent exchange during the phase inversion process. SEM images showed that the zwitterion-functionalized copolymer facilitated pore-formation during phase inversion. Blend membranes with concentration of zwitterion greater than 6 wt. % were prepared. However, the resulting membranes were found to be too brittle (i.e., not free-standing) for filtration experiments. So, the apparent limit of the zwitterion copolymer content in the blend membranes was around 6 wt. % for the BP-based polysulfone blend used as a control.

Without wishing to be bound by any particular theory, it is believed that a membrane formed from a blended composition, as disclosed hereinabove, comprising a bio-based PSf-co-SBAES copolymer and a bio-based PSf or BP-based PSf may also display asymmetrical structures, consisting of a dense skin-layer on a top surface with a thickness in the range of 1 to 500 nm and a porous sub-layer with a thickness around 0.5 to 15 μm. The porous sub-layer may include sponge-like micro-porous structures or finger-like pores and that one could control the thickness of the two types of layers by tuning the amount of the copolymer content, the amount of zwitterionic component of the copolymer, the time exposed to air for drying, the solvent and the non-solvent utilized, and/or the cast solution thickness.

Alternatively, dense, or pore-free, membranes may be and have been prepared by solution casting and air drying. In a typical process, a solution ranging in concentration from <1 wt. % polymer up to 40 wt. % polymer in a solvent (N,N-dimethylacetamide as an example) is cast into a dish or onto a substrate and the solvent is slowly evaporated to avoid the formation of pores. After drying under ambient conditions, the sample is dried under vacuum at increasing temperatures. Typically, the solvent will be evaporated under ambient conditions for 1 day, subjected to vacuum and 60° C. for 1 day, and then vacuum and 100° C. for an additional day. The times and temperatures used will depend on the polymer, the solvent, and the ambient conditions (temperature and humidity).

In an embodiment, the hydrophilic poly(ethylene glycol) (PEG; Mₙ=˜12,000 g/mol) may be used as a pore-forming agent and may serve as an additive to the composition comprising one or more of a bio-based PSf homopolymer, a bio-based PSf copolymer, and a BP-based PSf to prepare porous membranes. Asymmetric or dense membranes may be prepared as described above. However, when the membrane is immersed in a non-solvent bath, such as water in the case of polysulfones, the PEG blended with the PSf will be dissolved out leaving behind small pores. It is believed that the addition of PEG could dramatically influence the formation of pores in the support layer due to the increased hydrophilicity and viscosity of the blend solution, similar to that observed in BP-based PSf membrane.

Cross-sectional scanning electron micrographs of a control membrane formed from a BP-based PSf showed a thick dense layer around 2 μm and randomly dispersed macro-pores underneath. Cross-sectional scanning electron micrographs of a PSf/PEG blend membrane (3 wt. % PEG (12,000 g/mol) M-PEG) displayed a similar asymmetric structure with a highly porous sub-layer with thickness around 5 μm. These combined effects slowed the solvent/non-solvent exchange during phase inversion, which allowed for the formation of macrovoids.

In an aspect, there is a method of purifying water, the method comprising a step of filtering untreated water from a water source through the membrane of the present disclosure. In an embodiment, the method of purifying water is applied for water reclamation, wastewater treatment, or water purification.

In another aspect, there is a membrane electrode assembly, comprising:

an anode;

a cathode; and

a proton exchange membrane positioned between the anode and the cathode,

wherein the proton exchange membrane and at least one of the anode and the cathode comprises the bio-based polysulfone of the present disclosure. The bio-based PSf may be modified to include an anion (e.g., sulfonate) to enable proton exchange behavior.

Membrane Applications

Bio-based polysulfones of the present invention can be utilized in a number of membrane applications because they possess robust thermomechanical properties, stability in some organic solvents, and hydrolytic stability. Several applications, including water treatment (e.g., reverse osmosis desalination, for which bio-based PSFs are used as i) supports for thin-film composites and ii) the dense active layer; ultrafiltration; and dialysis) require water transport through the membrane. Water transport is correlated to the water partition coefficient, which has a direct relationship with the material hydrophilicity, as well as the water diffusion coefficient. Several industries that synthesize PSfs and/or manufacture membranes made from PSfs utilize multi-step processes to chemically modify the polymer and increase the membrane hydrophilicity. One advantage of the lignin-derived bio-based PSFs of the present invention from this perspective is the presence of methoxy groups on the phenyl ring, which potentially increase the hydrophilicity and eliminate the need for post-synthesis and/or post-processing chemical modification. BPA-based PSfs have a water contact angle of ˜85°, and industrial sources have cited that a water contact angle <60° would remove the need for chemical modification. In contrast, the methoxy groups provide a handle to perform chemical modification. The hydrolytic stability of PSfs enables these groups to be converted to phenols or carboxylates, which can be used to introduce chemical functionality through facile modification pathways. As disclosed hereinabove, model membranes based on BPA-based PSfs that may be modified to include a zwitterionic group are disclosed in '653 and Yang et al. Without wishing to be bound by any particular theory, it is believed that the BG-based PSfs of the present disclosure may completely avoid chemical modification to meet hydrophilicity target range.

In an aspect of the present invention, the composition as disclosed herein are used for Ionic Liquids (IL)/Membrane Technologies for advanced CO₂ removal. In particular, charge density on the bio-based PSfs as disclosed hereinabove may be controlled to optimize polymer-IL interactions to maximize IL loading capacity. Additionally, IL and polymer charge may be tailored to yield selective CO₂ solubility in the membrane. Furthermore, an aspect of the invention discloses high surface area modules to maximize CO₂ adsorption capacity and rate.

In an embodiment, the membranes as disclosed hereinabove may be used in the deep space operations due to reduced cost and weight for efficient CO₂ removal. In another embodiment, membranes may be integrated into other life support systems.

In an aspect, the membranes of the present disclosure may be used in catalytic systems to manufacture CH₄, HCOOH, and the like with great efficiency.

Aspects of the Invention

Certain illustrative, non-limiting aspects of the invention may be summarized as follows:
Aspect 1. A bio-based polysulfone comprising in polymerized form:
   (iii) at least one polymerizable lignin-based monomer having a structure corresponding to formula (I):

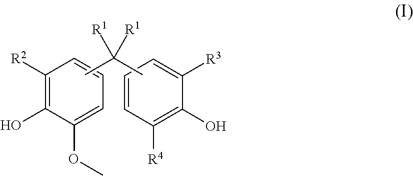

wherein each R¹ is independently either an H or a methyl group,
wherein R², R³, and R⁴ are each individually selected from an H or a methoxy group, and
(iv) at least one polymerizable 4,4′-dihalophenyl sulfone as a comonomer.
Aspect 2. The bio-based polysulfone of aspect 1, wherein the polymerizable lignin-based monomer comprises bisguaiacol A, bisguaiacol F, bisguaiacol-P, bisguaiacol-S, bisguaiacol-M, bisguaiacol-X, their regioisomers, and mixtures thereof.
Aspect 3. The bio-based polysulfone according to aspects 1-2, wherein the bio-based polysulfone is represented by the formula:

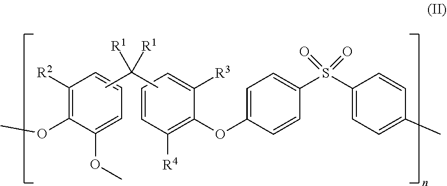

wherein n [degree of polymerization]=2-2000,
wherein each R¹ is independently either an H or a methyl group, and wherein R², R³, and R⁴ are each individually selected from an H or a methoxy group.
Aspect 4. The bio-based polysulfone of aspect 1, wherein the polymerizable lignin-based monomer comprises a mixture of p,p′-bisguaiacol F, m,p′-bisguaiacol F, and o,p′-bisguaiacol F, and wherein the resulting bio-based polysulfone is represented by the following structure:

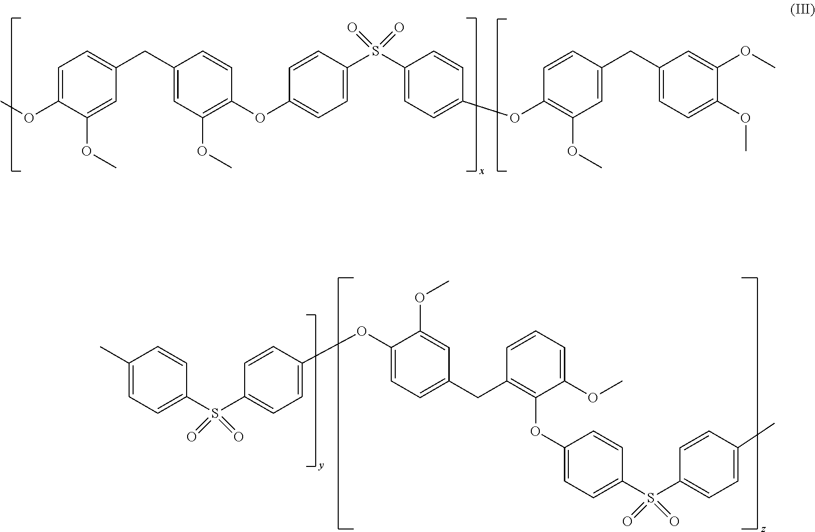

where x+y+z=1, 0<x≤1, 0<y≤1, and 0<z≤1; and where x, y, and z represent the molar fractions of the respective chemical units.
Aspect 5. The bio-based polysulfone of aspect 1, wherein the polymerizable lignin-based monomer comprises a mixture of p,p′-bisguaiacol A, m,p′-bisguaiacol A, and o,p′-bisguaiacol A, and wherein the resulting bio-based polysulfone is represented by the following structure:

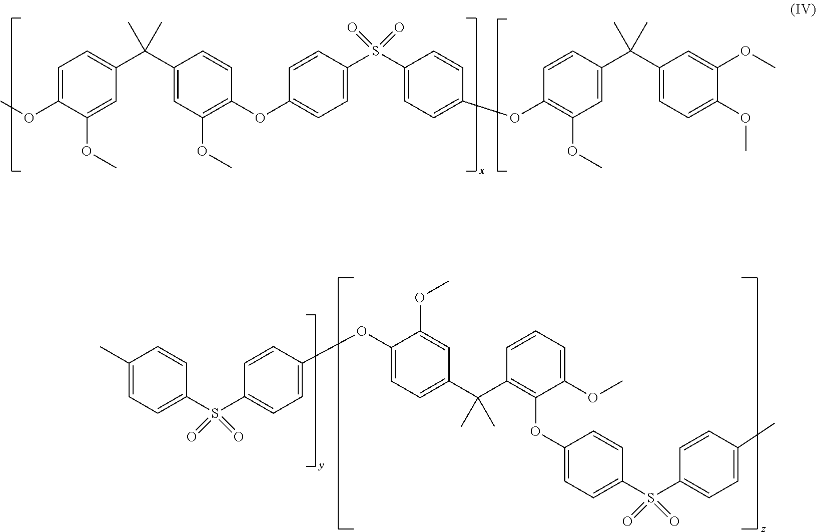

where x+y+z=1, 0<x≤1, 0<y≤1, and 0<z≤1; and where x, y, and z represent the molar fractions of the respective chemical units.
Aspect 6. The bio-based polysulfone of aspects 1-2, wherein the polymerizable lignin-based monomer is a mixture of a lignin-based monomer and a comonomer.
Aspect 7. The bio-based polysulfone of aspect 6, wherein the comonomer comprises at least one of 2,2′-diallylbisphenol A, bisphenol A, bisphenol F, bisphenol S, 2,2′-biphenol, 4,4′-biphenol, a multiphenol, and/or hydroquinone.
Aspect 8. The bio-based polysulfone of aspect 7, wherein the comonomer is 2,2′-diallylbisphenol A and wherein the resulting bio-based polysulfone is represented by the following structure:

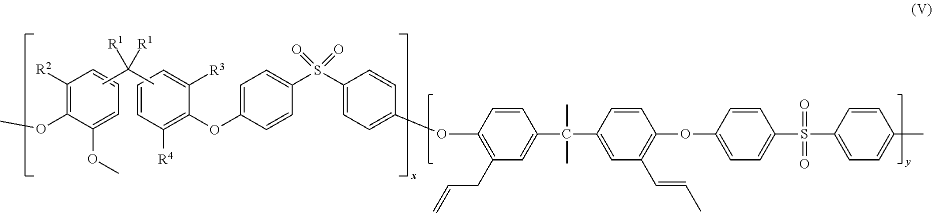

where x+y=1; and 0<x≤1, 0.25≤x≤1, 0<x≤0.25, or 0.25≤x≤0.75; x and y represent the molar fractions of the respective chemical units, wherein R¹ is either H or methyl group, and wherein R², R³, and R⁴ are each individually selected from an H or a methoxy group.
Aspect 9. The bio-based polysulfone according to any aspects 1-8, wherein the bio-based polysulfone is modified with one or more functional groups selected sulfonates, carboxylates, ammoniums, amines, alcohols, sulfobetaines, carboxybetaines, 2,2′-diallylbisphenol A and poly(ethylene glycol) (PEG).

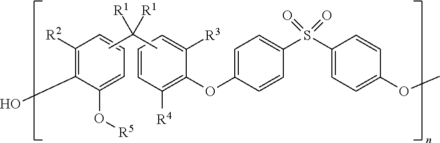

wherein n [degree of polymerization]=2-2000,
wherein R¹ is either an H or a methyl group, and
wherein R², R³, and R⁴ are each individually selected from an H or a methoxy group or the functionality described as R⁵ directly bonded to the phenyl ring, and wherein R⁵ is individually selected from an H, a COOH, an SO₃H, or an CH₂CH₂CH₂NH₂ and subsequent quarternary ammonium and betaine-type zwitterions.
Aspect 10. The bio-based polysulfone according to aspect 6, wherein the bio-based polysulfone is zwitterionic, and the zwitterionic functionality is selected from dimethylammonioacetate (carboxybetaine) groups, dimethylammoniopropyl sulfonate (sulfobetaine) groups, or combinations thereof.
Aspect 11. A composition comprising the bio-based polysulfone according to any one of aspects 1-10.
Aspect 12. The composition according to aspect 11, wherein the composition is a blend comprising one or more of:
   (i) a bio-based PSf homopolymer represented by structures (II)-(IV),
   (ii) a bio-based PSf-co-SBAES copolymer represented by structures (V)-(VI),
   (iii) a BP-based PSf, and
   (iv) a hydrophilic polymer.
Aspect 13. The composition according to aspect 11 or 12, further comprising one or more additives selected from the group consisting of tackifiers, plasticizers, viscosity modifiers, photoluminescent agent, anti-counterfeit and UV-reactive additives, dyes/pigments, anti-static materials, surfactants, and lubricants.
Aspect 14. A membrane comprising the composition of claim 11.
Aspect 15. An article comprising the membrane of aspect 14.
Aspect 16. The article of aspect 15, wherein the article is a filtering apparatus.
Aspect 17. The filtering apparatus of aspect 16, and wherein the filtering apparatus comprises a reverse osmosis apparatus, a dialysis apparatus, a nanofiltration apparatus, an ultrafiltration apparatus, or a microfiltration apparatus.
Aspect 18. The filtering apparatus according to aspect 17, wherein the membrane is configured to operate in a dead-end filtration mode, a cross-flow filtration mode, or a hollow fiber filtration mode.
Aspect 19. The membrane according to aspect 18, having a homogeneous pore size in the range from 0.5 nm to 10 μm, selected from the group consisting of:
   (i) a nanofiltration membrane with a homogeneous pore size in the range of 0.5 to 10 nm;
   (ii) a nanofiltration membrane with a homogeneous pore size in the range of 10 to 100 nm;
   (iii) an ultrafiltration membrane with a homogeneous pore size in the range of 100 nm to 1 μm; and
   (iv) a microfiltration membrane with a homogeneous pore size in the range of 1 to 10 μm.
Aspect 20. The filtering apparatus according to aspect 19, wherein the membrane is a reverse osmosis membrane having no pores or pores having a size in the range of 0.2-0.5 nm.
Aspect 21. A method of purifying water, the method comprising a step of filtering untreated water from a water source through the membrane according to claim 16.
Aspect 22. The method of claim 22, wherein the method is applied for water reclamation, wastewater treatment, or water purification.
Aspect 23. A membrane electrode assembly, comprising:
   an anode;
   a cathode; and
   a proton exchange membrane positioned between the anode and the cathode,
   wherein the proton exchange membrane and at least one of the anode and the cathode comprises the bio-based polysulfone of claim 1 modified with an anionic moiety to enable proton exchange.

As used herein, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

Within this specification, embodiments have been described in a way which enables a clear and concise specification to be written, but it is intended and will be appreciated that embodiments may be variously combined or separated without departing from the invention. For example, it will be appreciated that all preferred features described herein are applicable to all aspects of the invention described herein.

In some embodiments, the invention herein can be construed as excluding any element or process step that does not materially affect the basic and novel characteristics of the crosslinked hydrogels compositions, systems, and methods for making or using such systems. Additionally, in some embodiments, the invention can be construed as excluding any element or process step not specified herein.

### EXAMPLES

Examples of the present invention will now be described. The technical scope of the present invention is not limited to the examples described below.

Materials

Materials and their source are listed below:

Bisphenol A (BPA, ≥99%), bisphenol F (BPF, ≥98%), bis(4-fluorophenyl) sulfone (DFDPS, 99%), and potassium carbonate (K₂CO₃, ≥99%) were purchased from Sigma-Aldrich and dried in the vacuum oven for 24 h at room temperature before use. Toluene (99.8%) and tetrahydrofuran (4,4′-Dichlorodiphenyl sulfone (DCDPS, 98%) was purchased from Sigma-Aldrich and recrystallized from diethyl ether before use. Toluene (99.8%) and THF) (≥99.9%) were purchased from Sigma-Aldrich and used after passing through an MBraun SPS-800 solvent purification system. N,N-Dimethylacetamide (DMAc, 99.5%) and deuterated chloroform (CDCl₃, 99.8 atom % D, 0.03% (v/v) TMS) were purchased from Sigma-Aldrich and used as received. N,N-Dimethylformamide (DMF, ≥99.8%) was purchased from BDH® VMR and used as received. Guaiacol (98%, food-grade), vanillyl alcohol (≥98%), and syringol (99%) were purchased from Sigma-Aldrich. Amberlyst 15 hydrogen form (dry) was purchased from Fluka. Acetone (≥99.5%), ethyl acetate (≥99.5%), hexanes (98.5%), heptane (99%), and dichloromethane (DCM) (≥99.5%), were purchased from Fisher Scientific. Thioglycolic acid (98%), deuterated dimethyl sulfoxide, (DMSO-d₆, 99.5+% atom D), and deuterated chloroform (CDCl₃-d, 99.8+% atom D, contains 0.03 v/v % TMS) were purchased from Acros Organics. All chemicals were used as received.

Testing Methods

Characterization of PSfs

To determine the polymer structure, ¹H NMR spectroscopy was performed using a 600 MHz spectrometer for the monomers and a Varian 400 MHz spectrometer for the polymers. For this characterization, 20 mg of dried polymer was dissolved in 0.7 g CDCl₃.

Molecular Weight

Size exclusion chromatography (SEC) was carried out using a Waters Alliance e2695 HPLC system interfaced to a light scattering detector (miniDAWN TREOS) and an Optilab T-rEX differential refractive index (dRI) detector to determine the molecular weight of the polymers. The mobile phase was THF Optima (inhibitor-free) at a flow rate of 1.0 mL/min. The elution times of the PSf samples were compared to a universal calibration curve prepared from 6 low dispersity polystyrene standards of 5 kDa, 10 kDa, 30 kDa, 100 kDa, 200 kDa and 500 kDa molecular weights (Agilent technologies and Pressure chemical company). The molecular weight analysis was performed using Astra v6.1 software. The polymer solutions were prepared by dissolving the sample in THF at a concentration of ˜1.0 mg/mL and passing the solution through a 0.45 μm filter.

Thermogravimetric Analysis (TGA)

The thermal stability of the polymers was investigated using a Setaram TGA 92 instrument. ˜20 mg of the polymer was placed into an alumina crucible. The sample was heated from 15° C. to 30° C. in Ar gas, at a rate of 0.5 K/min to purge the sample cell. Then, the sample was heated to 600° C. at a rate of 10 K/min in Ar gas to test the thermal stability. TGA thermogram curves with respect to temperature are plotted. The temperature at which 5 wt. % of the sample decomposed (T_{5%}) is reported.

Differential Scanning Calorimetry (DSC)

To determine the glass transition temperatures (TO of the PSfs, a TA Instruments Q2000 calorimeter was used. The polymer samples were heated under N₂ at a rate of 10 K/min to 230° C., cooled to −80° C. at a set rate of 50 K/min, heated again at a rate of 10 K/min to 230° C., cooled again to −80° C. at a set rate of 50 K/min, and finally heated again at a rate of 10 K/min to 230° C. The polymer sample was loaded into a crimped aluminum pan, and the T_{g} of the polymer was determined from the data obtained from the third and last heating scan. TA's Universal analysis software and the integrated T_{g} function was used to determine the midpoint T_{g}.

Scanning Electron Microscopy (SEM)

The morphology of the surface and the cross-section of the dense membranes were analyzed by SEM (Philips, Model XL30 ESEM-FEG operating at 15 kV). To obtain a good cross-section image, the membranes were immersed in liquid nitrogen until frozen and then fractured to create a clean break. All samples were sputter-coated with a thin layer of gold to impart electric conductivity before testing.

Permeation Tests

A Sterlitech HP4750 stirred, dead-end filtration cell was used to evaluate the membrane permeate flux. To pressurize the feed solution inside the cell (e.g., 50-500 psi), N₂ gas was used. For the water flux measurements, the following equation was used.

$${J}_{ω} = \frac{V}{A Δ t}$$

Here, J_{w} is the water flux (L/m² h), V is the volume of permeate water collected (L), A is the effective area of the membrane (m²), and Δt is the sampling time (h). The effective area was 14.6 cm². Hence, the water flux was estimated by measuring the time required to collect some permeate volume that had passed through the membrane.

Mechanical Testing

Uniaxial tensile testing was performed to evaluate the mechanical behavior of the dense membranes. The stress-strain curve, Young's Modulus (E), elongation at break, and ultimate stress at break were measured using a Discovery Hybrid Rheometer 2 (DHR2) from TA Instruments. The film/fiber tension geometry was used and the cross head speed was 100 μm/s. The membranes were cut into rectangular shapes of ˜1 cm by 10 cm with a thickness of ˜0.1-0.3 mm and taped to paper to cushion the grip of the machine. All tests were performed at ambient conditions. Three replicates were analyzed, and the average values are reported.

Water Uptake Measurements

To measure the water uptake, pre-weighed and dried membranes were submerged in deionized water at room temperature and weighed periodically until a constant weight was achieved. During each weight measurement, the membranes were blotted dry to remove any water on the membrane surface. The membranes were then dried under vacuum at 100° C. for 24 h and weighed again. The water uptake is measured using the following formula.

$$Water uptake ( \% ) = ( \frac{{w}_{w} - {w}_{d}}{{w}_{d}} ) \times 100$$

Here, W_{w} and W_{d} are the weights of the wet and dry membrane, respectively. Membrane morphology and properties

Membrane composition was determined by fourier transform infrared (FT-IR) spectrum (4000-400 cm⁻¹) on a Nicolet™ iS™ 50 FT-IR spectrometer at 4 cm⁻¹ resolution and 32 scans. Membrane thickness and morphology were characterized using an environmental scanning electron microscope Philips XL30 ESEM-FEG operating at 4 kV. Membrane samples were freeze-fractured using liquid nitrogen for cross-sectional examination, and sputter coated with gold before imaging. Membrane surface morphology and roughness were obtained using atomic force microscopy (AFM). Samples for AFM were scanned by Dimension Multimode 8 with tapping mode. The scanning speed was set to 1 Hz, and scanning size was 256×256. Data were analyzed by Gwyddion software. Surface hydrophilicity of the membranes was tested by water contact angle measurement (Attension Theta optical tensiometers, Biolin Scientific). Five random spots on the surface were measured for each membrane sample at room temperature and the average value was taken.

Membrane Separation Performance

Filtration experiments were performed on 49 mm diameter membranes using a 300 mL Sterlitech HP4750 stirred, dead-end filtration cell with an effective filtration area of 14.6 cm². A Sartorius ED3202S extend precision balance connected with a LabVIEW software was used to monitor the flow rates every 3 s. All filtration tests were performed at room temperature and feed solution was stirred in 125 rpm by using a Teflon-coated magnetic stir bar to reduce concentration polarization. All tested membranes were supported by a polyester fabric support (Whatman, 47 mm). Before loading into the filtration module, the membranes were prepared by the NIPS process noted above. After the membranes were recovered from the coagulation bath, they were airdried overnight, dipped into a 50/50 isopropanol/water (vol %) mixture for 20-30 min, and rinsed with deionized water before use. All filtration membranes were pre-pressurized under a hydrostatic pressure of 8 bar for at least 30 min, and then following the filtration tests were performed and recorded with the same hydrostatic pressure of 8 bar. Before each filtration test was performed, deionized water was first passed through the membrane until the system remained stable for at least 30 min. This pure water permeate, ˜1.0 g was discarded prior to the salt rejection experiments. Flux is the flow rate through the mem-brane normalized by membrane active area. Permeance is a membrane transport property that normalizes the flux with the applied trans-membrane pressure, and is obtained by

$$\begin{matrix}{J}_{v} = \frac{{O}_{y}}{{A}_{m}} & ( 1 ) \\ {L}_{p} = \frac{{J}_{V}}{Δ P - Δ π} & ( 2 )\end{matrix}$$

where Jᵥ is the volumetric filtrate flux across the membrane (L m⁻² h⁻¹), Qᵥ is the volume flow rate (L h⁻¹), Aₘ is the effective membrane area (14.6 cm²), ΔP is the hydrostatic pressure (bar), Δn is the osmotic pressure (bar), and Lₚ is the permeance of the membrane (L m⁻² h⁻¹ bar⁻¹).

To characterize the salt selectivity of the membranes, sodium chloride was used as the salt during filtration tests. A 2.0 g/L aqueous solution of sodium chloride was filtered through the membrane immediately after the pure water permeance tests. The salt rejection and salt passage were calculated by the definition that

$$\begin{matrix}R ( \% ) = ( 1 - \frac{{c}_{P}}{{c}_{F}} ) & ( 3 ) \\ SP ( \% ) = 100 \% - R ( \% ) & ( 4 )\end{matrix}$$

where R is the salt rejection (%), SP is the salt passage (%), C_{P} is the permeate concentration (g/L), and C_{F} is the feed concentration (g/L). C_{P} and C_{F} were measured by an Accumet Excel XL50 conductivity meter. For each copolymer ratio, three membrane samples prepared under same conditions were tested.

Synthesis of Bisguaiacol Compounds

BGA was synthesized via the electrophilic aromatic condensation of guaiacol and acetone in the presence of a solid and recyclable acid catalyst, such as Amberlyst 15 hydrogen form (dry), as shown in FIG. 2A(a). The reaction was conducted in a large excess of guaiacol to minimize the formation of by-products from the self-condensation of acetone. The availability of bio-based acetone along with recyclable catalyst makes for a potentially greener process relative to BPA synthesis. Similarly, BGF was synthesized from guaiacol and vanillyl alcohol, as shown in FIG. 2A(b), and the direct condensation approach eliminates the use of hazardous formaldehyde inherent in BPF production. The final yields of both bisguaiacol (BGF and BGA) compounds were ˜40 mol % with respect to the limiting reactant i.e., acetone for BGA and vanillyl alcohol for BGF. The detailed bisguaiacol synthesis and purification procedures, in addition to ¹H NMR spectra is described below:

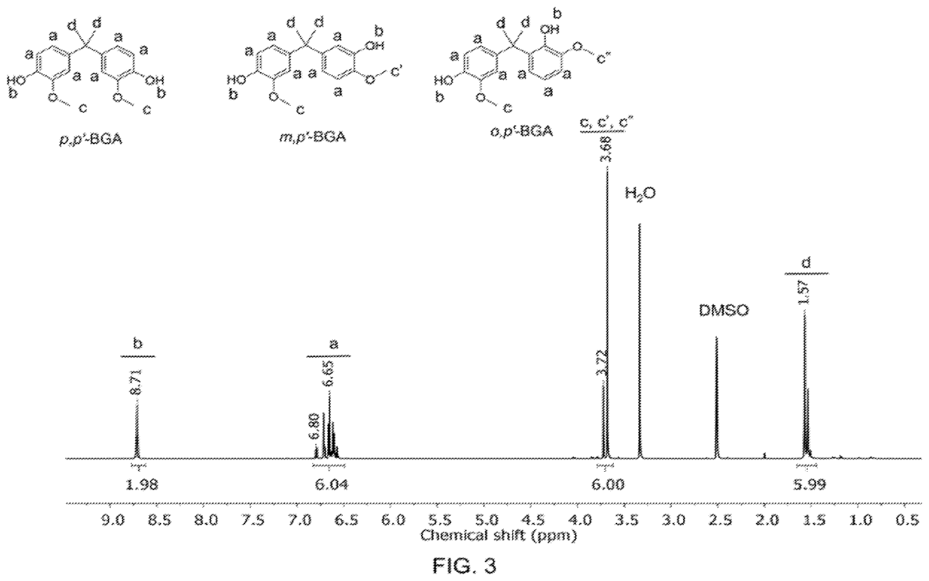

BGA synthesis: Guaiacol and acetone were charged at a 13:1 molar ratio in a single-neck, round-bottom flask equipped with a condenser and magnetic stirrer. Amberlyst 15 hydrogen form (0.0268 g/cm³ of the liquid phase) as an acid catalyst was loaded into the reaction flask, followed by the addition of thioglycolic acid (˜0.2 wt. % with respect to the catalyst) as a promotor. The reaction mixture was sparged with argon gas for 1 min, and the mixture was heated to 100° C. and held at that temperature for 30 h. Then, the reaction was quenched by placing the flask in an ice bath, and the solid catalyst was filtered from the solution using Buchner funnel (grade 4 Whatman filter paper). The solids were rinsed with DCM to collect any residual product. The liquid phase was then washed with deionized water (3 times) in a separatory funnel. The organic phase was collected, and the solvent was removed by rotary evaporation. Excess guaiacol was separated from BGA by flash column chromatography (Biotage® Selekt Systems, Biotage® Sfär Silica columns—60 μm, 100 g) with a step gradient of ethyl acetate and hexanes as the mobile phase. Finally, the BGA was recrystallized in hot heptane, and the product was dried at room temperature under vacuum. The chemical structure of BGA was confirmed via ¹H NMR spectroscopy, as shown in FIG. 3. The yield of isomeric BGA was ˜40 mol % with respect to the acetone. ¹H NMR (600 MHz, DMSO-d₆) δ 8.71 (d, J=5.4 Hz, 2H), 6.82-6.49 (m, 6H), 3.70 (d, J=25.7 Hz, 6H), 1.55 (d, J=18.4 Hz, 6H).

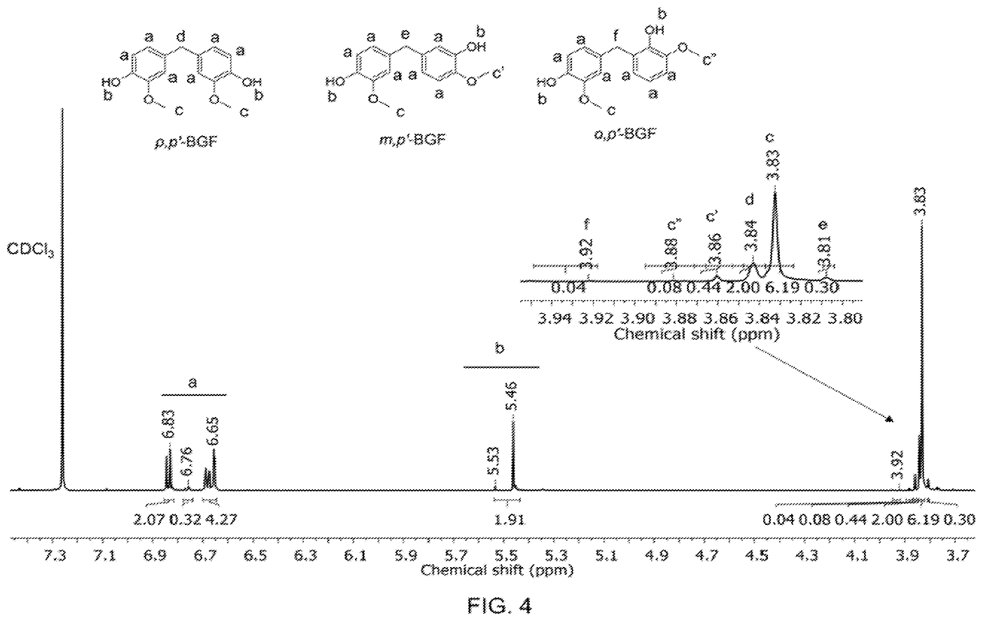

BGF synthesis: BGF was synthesized by loading Guaiacol (4 eq.) and vanillyl alcohol (1 eq.) into a single-neck, round-bottom flask equipped with a magnetic stir bar. The solution was heated to 70° C., purged with argon gas, and held for 40 min. Then, under argon flow, Amberlyst 15 hydrogen form (dry) was added to the reaction mixture, and the reaction was allowed to proceed for 50 min. BGF was purified using a similar procedure to BGA. The final yield of isomeric BGF was ˜40 mol % with respect to the vanillyl alcohol. The chemical structure of BGF was confirmed via ¹H NMR spectroscopy, as shown in FIG. 4. ¹H NMR (600 MHz, CDCl₃-d) δ 6.84 (d, J=8.0 Hz, 2H), 6.70-6.63 (m, 4H), 5.46 (s, 2H), 3.84 (s, 2H), 3.83 (s, 6H).

Synthesis Protocol to Prepare the Bio-Based PSfs

The bio-based PSfs were synthesized via step growth polymerization. The protocol to synthesize BGA-based PSf is provided as a representative example:

### Example 1: BGA-Based PSf

BGA (0.50 g, 1.72 mmol), DFDPS (0.47 g, 1.83 mmol), K₂CO₃ (0.27 g, 1.93 mmol), DMAc (10 mL) and toluene (4 mL) were all added to a two neck 250 mL flask equipped with a condenser, Dean Stark trap, nitrogen inlet/outlet, and a mechanical stirrer. The solution was heated to 135° C. for 2 h under nitrogen to azeotropically distill out the water and toluene. Then, the reaction was continued for 24 h at 135° C. The same experiment was repeated for all polymers synthesized with the same molar ratios. After the reaction, the mixture was cooled, filtered to remove salts, and precipitated by addition to stirring DI water. The isolated polymers were dried under vacuum at room temperature overnight, redissolved in THF and precipitated by addition to stirring DI water two more times. The polymer was dried again under vacuum at room temperature.

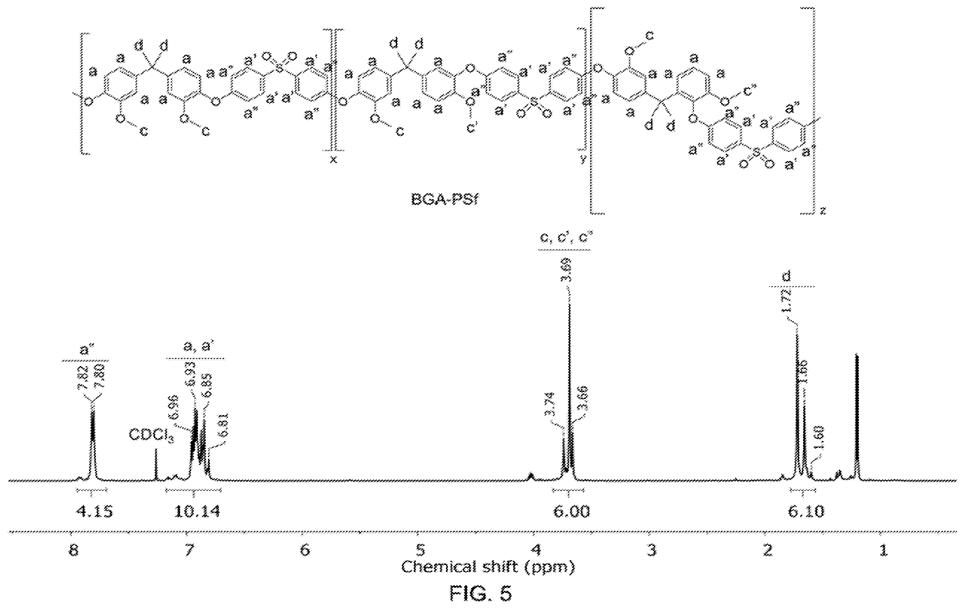

¹H NMR spectrum of BGA-based PSf with TMS as an internal standard (CDCl₃, 400 MHz, δ) is shown in FIG. 5.

The thermal properties of the resulting renewable BGA-based PSf and its petroleum-based counterpart are summarized in Table 1.

### Example 2: BGF-Based PSf

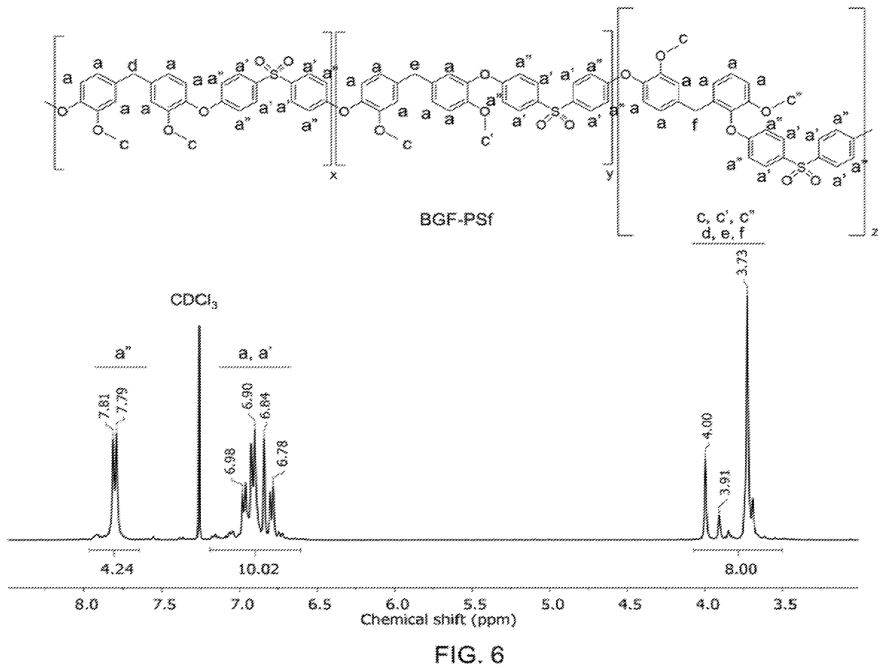

A procedure similar to that used in the Example 1 was used except that BGF was used instead of BGA. The thermal properties of the resulting renewable BGF-based PSf and its petroleum-based counterpart are summarized in Table 1. ¹H NMR spectrum of BFA-based PSf with TMS as an internal standard (CDCl₃, 400 MHz, 6) is shown in FIG. 6.

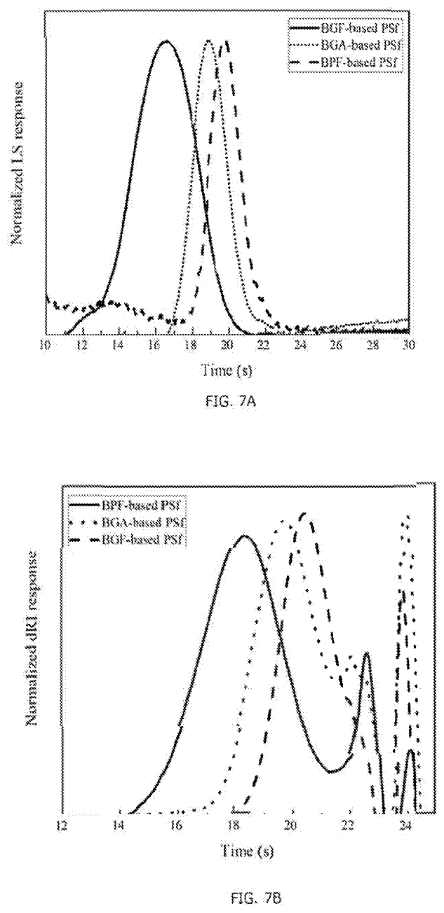

FIGS. 7A and 7B displays exemplary SEC traces of BGF-based PSf, BGA-based PSf and BPF-based PSf from the light scattering (LS) detector (FIG. 7A) and the refractive index (RI) detector (FIG. 7B) after the polymerization was carried out for 24 h. The elution curves demonstrate unimodal Gaussian distributions. Dispersity (D) values are calculated to be 1.70, 1.67 and 1.23 for BGF-based PSf, BGA-based PSf and BPF-based PSf polymers, respectively. The dispersity should theoretically reach 2.0 at full conversion, and lower values could indicate unusual polymerization behavior, unique solubility or solution characteristics in THF (used for SEC analysis), or incomplete conversion. That the dispersities of BGF-based PSf and BGA-based PSf are approaching 2.0 is good and suggests characteristic step-growth polymerization behavior. The data available suggest the polymerization between BGA or BGF with the dihalophenyl sulfone proceeds through a standard step-growth polymerization mechanism. The number-average molecular weights (Mₙ) achieved after 24 h were 28.5 kDa, 29.4 kDa and 26.1 kDa for BGF-based PSf, BPF-based PSf, and BGA-based PSf, respectively. The weight average molecular weights (Mw) were 48.5 kDa, 36.2 kDa and 43.7 kDa for BGF-based PSf, BPF-based PSf, and BGA-based PSf, respectively. These results illustrate the similarity in the syntheses of the bio-based PSfs and the BP-based PSfs.

TABLE 1
Regioisomer content, number-average molecular weight (Mₙ), weight-average
molecular weight (M_{w}), dispersity (Ð), contact angle, glass transition temperature
(T_{g}), thermal degradation at 5% weight loss (T_{D,5%},), and Young's modulus of PSfs

| | Regioisomer | | | | | | | |
|---|---|---|---|---|---|---|---|---|
| BG and | content^{a} | | | | | | | Young's |
| BP-based | (mol %) | mₙ^{b} | m_{w}^{b} | | | T_{g}^{d} | T_{D,5%}^{e} | modulus^{f} |
| PSfs | p,p’:m,p’:o,p’ | (kDa) | (kDa) | Ð^{b} | Contact angle^{c} (°) | (° C.) | (° C.) | (MPa) |
| BGF | 83:15:2 | 28.5 | 48.5 | 1.70 | 82.3 ± 2.0 | 162 | 402 | 430 ± 30 |
| BPF | N/A | 29.4 | 36.2 | 1.23 | 84.6 ± 1.2 | 187 | 380 | 54 ± 8 |
| BGA | **** | 26.1 | 43.7 | 1.67 | 83.4 ± 2.5 | 163 | 410 | 1216 ± 340 |
| BPA | N/A | 34.9 | 64.7 | 1.84 | 84.5 ± 2.4 | 170 | 523 | 1010 ± 210 |

^{a}Calculated by ¹H NMR spectroscopy.
^{b}Determined by SEC.
^{c}Determined via water contact angle measurements at room temperature.
^{d}Determined by DSC at a heating rate of 10° C./min.
^{e}Determined by TGA at a heating rate of 10° C./min in argon atmosphere.
^{f}Determined by stress-strain curves from tensile testing in compression mode.

The thermal stability of the bio-based PSfs suggest amenability to melt processing at temperatures above the T_{g} as well as for use in high temperature applications. Similarly, the T_{g} is in the range of high polymers and high performance thermoplastics.

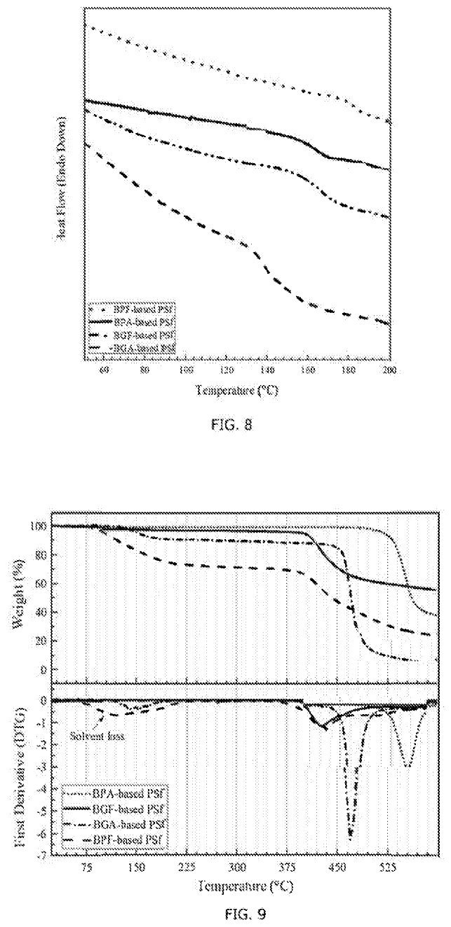

It is worth noting that the thermal properties of these lignin-derived PSfs fall in the range of high-performance thermoplastics. TGA and DSC scans are shown in FIGS. 8-9 and the TGA/DSC analysis summarized in Table 1 shows that the T_{g}s of bio-based PSfs were nearly equivalent to those of their BP-based PSf counterparts.

The DSC thermograms shown in FIG. 8 indicate that the T_{g} for the BGA-based PSf and BGF-based PSf were 136° C. and 165° C., respectively. The discrepancy in T_{g} from Table 1 and FIG. 8 for the BGA-based PSf could be related to differences in molecular weight. Thus, we report that the T_{g} of BGA-based PSfs can range from 136−163° C., which is very comparable to BP-based PSfs. When compared head-to-head to the BP-PSfs, these numbers are slightly lower but fall well within the range of other high performance thermoplastics. These T_{g} values would allow for operation in many high temperature applications and would allow for sterilization via autoclave for biomedical applications. The reduction in T_{g} when comparing the BPF-based PSf and BGF-based PSf as well as when comparing BPA-PSf and BGA-based PSf is potentially due to the increase in free volume caused by the added methoxy groups on the phenyl ring. This increase in free volume could cause a greater degree of rotational freedom that would allow for segmental motion at a lower temperature.

The thermal stability of the PSfs were tested using thermogravimetric analysis (TGA), as shown in shown in FIG. 9. The BPA-based PSf and BPF-based PSf were subjected to additional drying prior to analysis; therefore, the samples exhibited no weight loss prior to degradation >400° C. However, the BGA-based PSf and BPF-based PSf showed weight loss attributed to solvent evaporation in the temperature range from 50-250° C. from the evaporation of N,N-dimethylacetamide, dimethylsulfoxide, and/or N,N-dimethylformamide, which were used during the synthesis and membrane casting.

By overlooking the weight loss from solvent evaporation, it becomes apparent that the bio-based PSfs share a similar thermal stability as the BP-based PSfs. The BGF-based PSf was stable up to ˜410° C. and the BGA-based PSf was stable up to ˜465° C. The trend is similar to the BP-based PSf with the BGA-based PSf exhibiting a greater thermal stability than the BGF-based PSf. In the case of both bio-based PSf the thermal stability is excellent and would enable melt processing and use for high temperature applications.

Size exclusion chromatography (SEC) of BGF-based PSfs at different reaction times (7 h, 21 h, 31 h, 45 h, and 71 h) from light scattering detector and refractive index detector was done. Results of the study are summarized below in Table 2. It should be noted that first aliquot at 7 h had high MW shoulder in the LS detector trace and the MW at 7 h was about the same as that at 45 h data point from the first reaction.

TABLE 2

| DFDPS:BGF-4 | BGF-4:K₂CO₃ | Temperature | | Mₙ | M_{w} | |
|---|---|---|---|---|---|---|
| (molar ratio) | (molar ratio) | (° C.) | Reaction time (h) | (kDa) | (kDa) | Ð |
| 100:94 | 20:21 | 140 | 7 | 26.5 | 39.6 | 1.49 |
| | | | 21 | 18.2 | 25.6 | 1.40 |
| | | | 31 | 25.2 | 40.6 | 1.61 |
| | | | 45 | 26.7 | 48.1 | 1.80 |
| | | | 71 | 28.5 | 48.5 | 1.70 |

Lignin-derived PSfs exhibited higher Young's moduli (E) than their petroleum-derived analogues. Additionally, BGA-based PSfs showed equivalent or slightly higher E relative to BPA-derived PSfs due to the structural similarity of BGA with BPA.

### Example 3: Fabrication of Bio-Based PSf Membranes

The polymers were first dissolved in a high boiling point solvent (N,N-dimethylacetamide) in the amount corresponding to the concentration of 2.5 wt. %. The polymer solution was then passed through a 0.45 μm syringe filter, sonicated in a glass vial inside an ultra-sonic bath for 30 min and left to sit in the glass vial overnight to degas and remove any bubbles that may have formed. The solution was then poured into a Pyrex petri dish and left under vacuum at room temperature overnight. The vacuum oven temperature was then increased to 60° C. for 24 h, and then to 100° C. for 24 h to gradually remove the solvent. To detach the membrane, the petri dish was immersed in a mixture of water and methanol overnight. The membrane was then carefully peeled off and completely dried in the vacuum oven for 24 h.

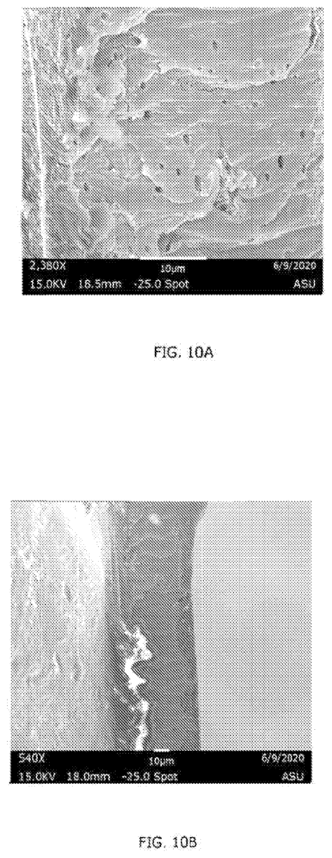

FIGS. 10A-10C shows exemplary cross-sectional SEM images of BGF-based PSf membranes. SEM images of the BGF-based PSf membrane cross-sections show the morphologies of the membrane structure made by the aforementioned membrane casting method. The membranes have a homogeneous pattern of small pores (<˜1 μm) uniformly dispersed throughout the membrane. The membrane width is 30 μm. The casting protocol can be altered to yield completely dense membranes (slower solvent evaporation) or asymmetric membranes with dense skin layer (˜100 nm thick) and a porous support beneath using the NIPS/SNIPS process. These images that demonstrate the ability to cast polymer membranes from the bio-based PSfs provide strong support for the potential use in membrane separations.

Water Permeance

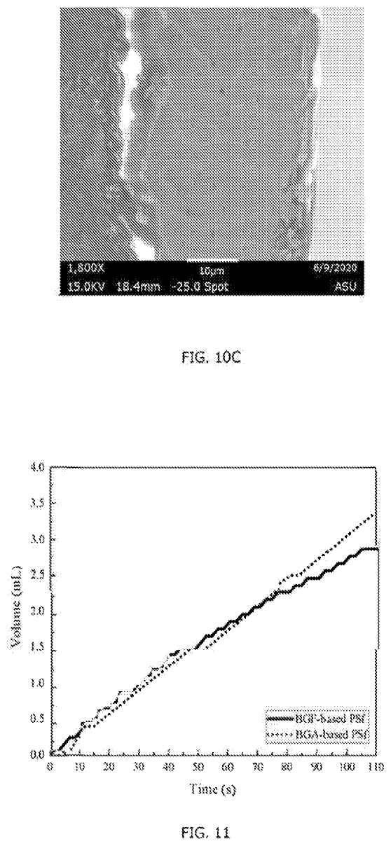

FIG. 11 shows exemplary plot of pure water permeation for BGF-based PSf and BGA-based PSf as a function of time. The test was carried out at a pressure of 30 psi and temperature of 25° C. The linear slope of the volume collected over time (mL/s) can be normalized by the membrane surface area (14.6 cm²) to obtain a water flux. Water permeation for BGA-based PSf and BGF-based PSf were measured using a dead-end filtration cell and passing water a pressure of 30 psi through the polymer filter. The volume was collected and measured as a function of time, the linear slope (mL/s) is normalized by the membrane surface area to obtain the water flux, which was 70.7 L/m² h for BGA-based PSf and 41.9 L/m² h for BGF-based PSf. During the testing of BGF-based PSf the pressure was increased to −500 psi without membrane failure, indicative of a strong membrane capable of withstanding the high transmembrane pressure drops experience during membrane separations (however, the flux reported for both membranes was taken at the same pressure of 30 psi). These fluxes are close to published values of pure water permeation flux for BP-based PSf membranes under the same experimental conditions (Habibi et al.).

### Example 4: Synthesis of PAES-Co-SBAES Copolymers

### (i) Step 4A: Synthesis of allyl-modified poly(arylene ether sulfone) (A-PAES) copolymer

The allyl-containing poly(arylene ether sulfone) copolymer was synthesized via traditional step-growth polymerization. BPA (7.54 g, 33.06 mmol), DABA (0.53 g, 1.74 mmol), DCDPS (10 g, 34.8 mmol), K2CO3 (4.8 g, 34.8 mmol), and 18-Crown-6 (0.1 g) were added to a three-neck, 250-mL flask equipped with a condenser, Dean Stark trap, nitrogen inlet/outlet, and a mechanical stirrer. DMAc (95 mL) and toluene (46 mL) were added to the flask to dissolve the monomers. The solution was heated under reflux at 110° C. for 4 h while the toluene-water azeotrope was removed from the reaction mixture, and then the toluene was completely removed by slowly increasing the temperature to 130° C. The reaction was continued for 36 h at 130° C. The reaction mixture was cooled to room temperature and diluted with 200 mL of chloroform. It was filtered to remove the salt, then stirred with excess 36.5-38% HCl for 2 h at 25° C., and precipitated by addition to stirring DI water. The polymer was filtered and dried under vacuum at 100° C. for 24 h. Then, the polymer was dissolved in chloroform, passed through a 0.45 μm Teflon® filter, then isolated by precipitation in DI water. The product (A-PAES(1), referred as A-PAES if not specified) was dried at 100° C. under vacuum for 24 h.

### (ii) Step 4B: Synthesis of Tertiary Amine-Modified PAES (TA-PAES) Copolymer

The synthesized A-PAES copolymer from Step 4A (5 g, 1 mmol), 2-(dimethylamino) ethanethiol (1.4 g, 10 equiv.), and DMPA (76.8 mg, 0.3 equiv.) were dissolved in DMF (20 mL) to perform a post-polymerization modification via the thiol-ene click reaction. The reactor flask was purged with nitrogen for 15 min. Irradiation with UVGL-15 compact UV lamp (365 nm) was carried out for 2 h at 23° C. The solution was concentrated using a rotary evaporator, and the remaining solution was diluted with THF (5 mL) and dialyzed against THF in a dialysis tube (1 kDa MWCO) for 3 days. The THF outside the dialysis tube was exchanged with fresh THF every 2 h over the first 10 h and then every 6 h until completion. The polymer was then isolated by precipitation in DI water, and the product was dried at 100° C. under vacuum for 24 h.

### (iii) Step 4C: Synthesis of PAES-Co-SBAES Copolymers

To a solution of TA-PAES from Step 4B (4.8 g, 1 mmol) in DMF (20 mL), 1,3-propane sultone (244.3 mg, 2 equiv.) was added. The solution was stirred at room temperature for 1 h and at 60° C. for 18 h. The solution was concentrated using a rotary evaporator, and the remaining solution was diluted with THF (5 mL) and dialyzed against THF in a dialysis tube (1 kDa MWCO) for 3 days. The THF outside the dialysis tube was ex-changed with fresh THF every 2 h over the first 10 h and then every 6 h until completion. The polymer was then isolated by precipitation in DI water, and the product was dried at 100° C. under vacuum for 24 h.

### Example 5: Synthesis of Bio-Based BGA-Based PSf-Co-SBAES Copolymers

A procedure similar to that described in Example 4 above is repeated except that instead of BPA, a lignin-derived monomer BGA is used.

### Example 6: Synthesis of Bio-Based BGA-Based PSf-Co-SBAES Copolymers

A procedure similar to that described in Example 4 above is repeated except that instead of BPA, a lignin-derived monomer BGF is used.

### Example 7: Fabrication of BGA-Based and BGF-Based PSf/PAES-Co-SBAES Blend Membranes

A procedure similar to that described in Example 3 is used to make membranes from the bio-based BGA-based PSf-co-SBAES copolymers of Example 5 and bio-based BGF-based PSf-co-SBAES copolymers of Example 6.

1. A bio-based polysulfone comprising in polymerized form:
(i) at least one polymerizable lignin-based monomer having a structure corresponding to formula (I): 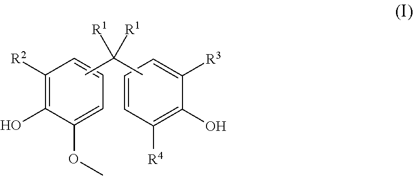
wherein each R¹ is independently either an H or a methyl group,
wherein R², R³, and R⁴ are each individually selected from an H or a methoxy group, and
(ii) at least one polymerizable 4,4′-dihalophenyl sulfone as a comonomer.

2. The bio-based polysulfone of claim 1, wherein the polymerizable lignin-based monomer comprises bisguaiacol A, bisguaiacol F, bisguaiacol-P, bisguaiacol-S, bisguaiacol-M, bisguaiacol-X, their regioisomers, and mixtures thereof.

3. The bio-based polysulfone of claim 1, wherein the bio-based polysulfone is represented by the formula: 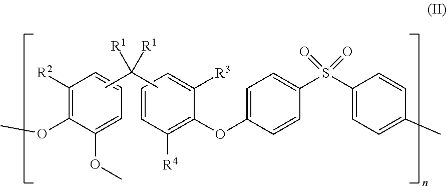
wherein n [degree of polymerization]=2-2000,
wherein each R¹ is independently either an H or a methyl group, and
wherein R², R³, and R⁴ are each individually selected from an H or a methoxy group.

4. The bio-based polysulfone of claim 1, wherein the polymerizable lignin-based monomer comprises a mixture of p,p′-bisguaiacol F, m,p′-bisguaiacol F, and o,p′-bisguaiacol F, and wherein the resulting bio-based polysulfone is represented by the following structure: 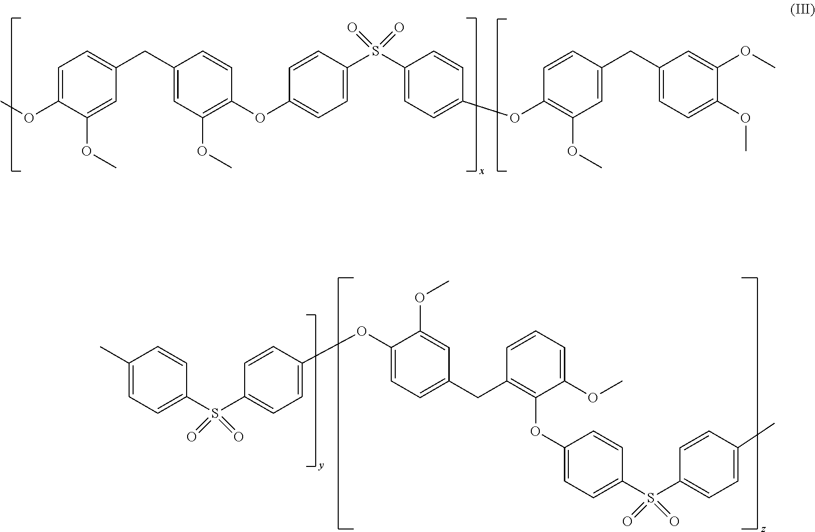
where x+y+z=1, 0<x≤1, 0<y≤1, and 0<z≤1; and where x, y, and z represent the molar fractions of the respective chemical units.

5. The bio-based polysulfone of claim 1, wherein the polymerizable lignin-based monomer comprises a mixture of p,p′-bisguaiacol A, m,p′-bisguaiacol A, and o,p′-bisguaiacol A, and wherein the resulting bio-based polysulfone is represented by the following structure: 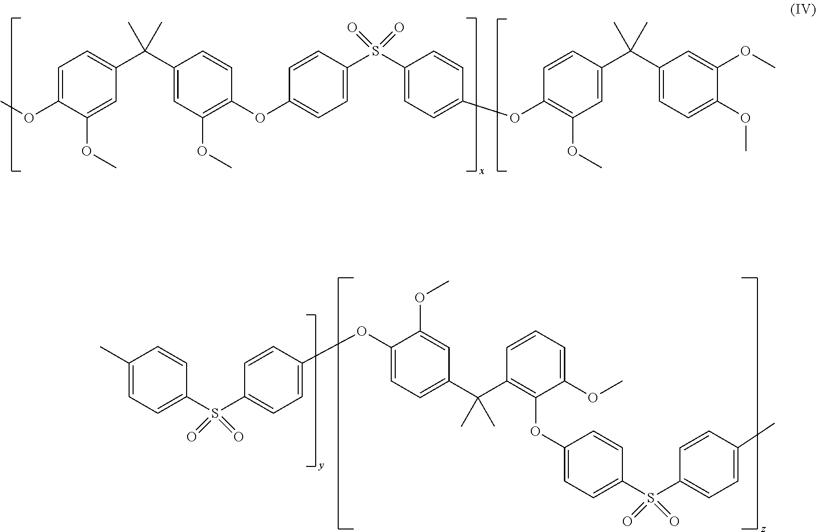
where x+y+z=1, 0<x≤1, 0<y≤1, and 0<z≤1; and where x, y, and z represent the molar fractions of the respective chemical units.

6. The bio-based polysulfone of claim 1, wherein the polymerizable lignin-based monomer is a mixture of a lignin-based monomer and a comonomer.

7. The bio-based polysulfone of claim 6, wherein the comonomer comprises at least one of 2,2′-diallylbisphenol A, bisphenol A, bisphenol F, bisphenol S, 2,2′-biphenol, 4,4′-biphenol, multiphenol and/or hydroquinone.

8. The bio-based polysulfone of claim 7, wherein the comonomer is 2,2′-diallylbisphenol A and wherein the resulting bio-based polysulfone is represented by the following structure: 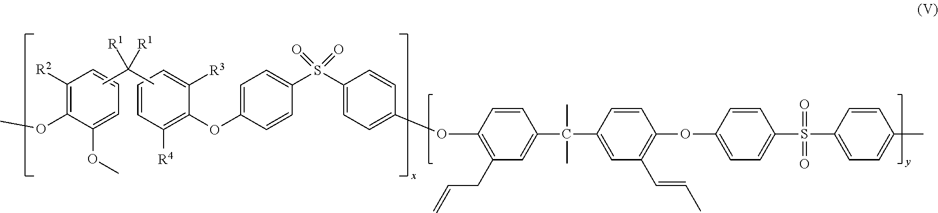
wherein x+y=1, 0<x≤1, and where x and y represent the molar fractions of the respective chemical units,
wherein R¹ is either H or methyl group, and
wherein R², R³, and R⁴ are each individually selected from an H or a methoxy group.

9. The bio-based polysulfone of claim 1, wherein the bio-based polysulfone is modified with one or more functional groups selected from sulfonates, carboxylates, ammoniums, amines, alcohols, sulfobetaines, carboxybetaines, 2,2′-diallylbisphenol A, and poly(ethylene glycol) (PEG). 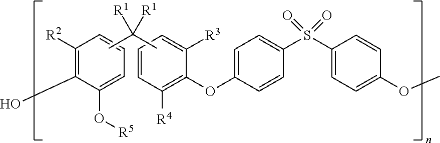
wherein n [degree of polymerization]=2-2000,
wherein R¹ is either an H or a methyl group, and
wherein R², R³, and R⁴ are each individually selected from an H or a methoxy group or the functionality described as O—R⁵ directly bonded to the phenyl ring, and wherein R⁵ is individually selected from an H, a COOH, an SO₃H, or an CH₂CH₂CH₂NH₂ and subsequent quarternary ammonium and betaine-type zwitterions.

10. The bio-based polysulfone of claim 6, wherein the bio-based polysulfone is zwitterionic, and the zwitterionic functionality is selected from dimethylammonioacetate (carboxybetaine) groups, dimethylammoniopropyl sulfonate (sulfobetaine) groups, or combinations thereof.

11. A composition comprising the bio-based polysulfone according to claim 1.

12. The composition of claim 11, wherein the composition is a blend comprising one or more of:
(i) a bio-based PSf homopolymer represented by structures (II)-(IV), 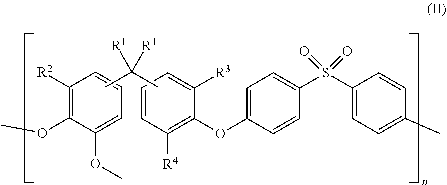
wherein n [degree of polymerization]=2-2000; each R¹ is independently either an H or a methyl group; and R², R³, and R⁴ are each individually selected from an H or a methoxy group, 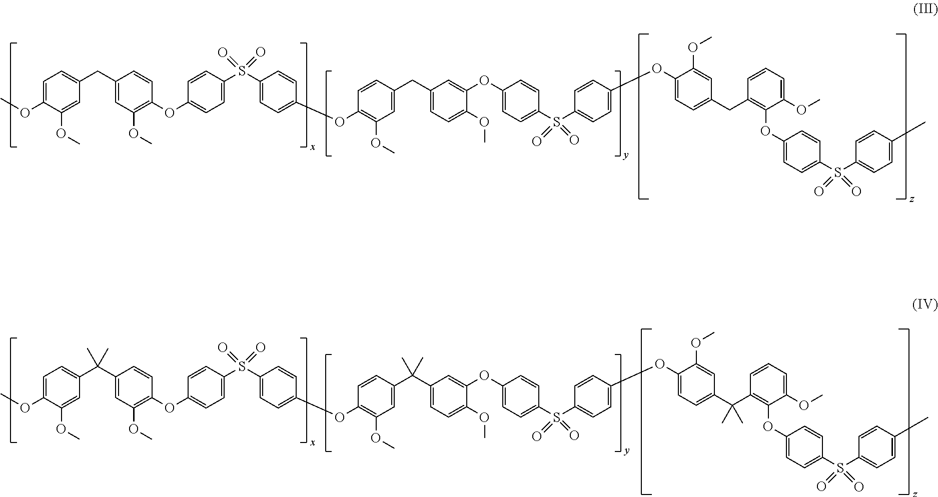
(ii) a bio-based PSf-co-SBAES copolymer represented by structures (V)-(VI), 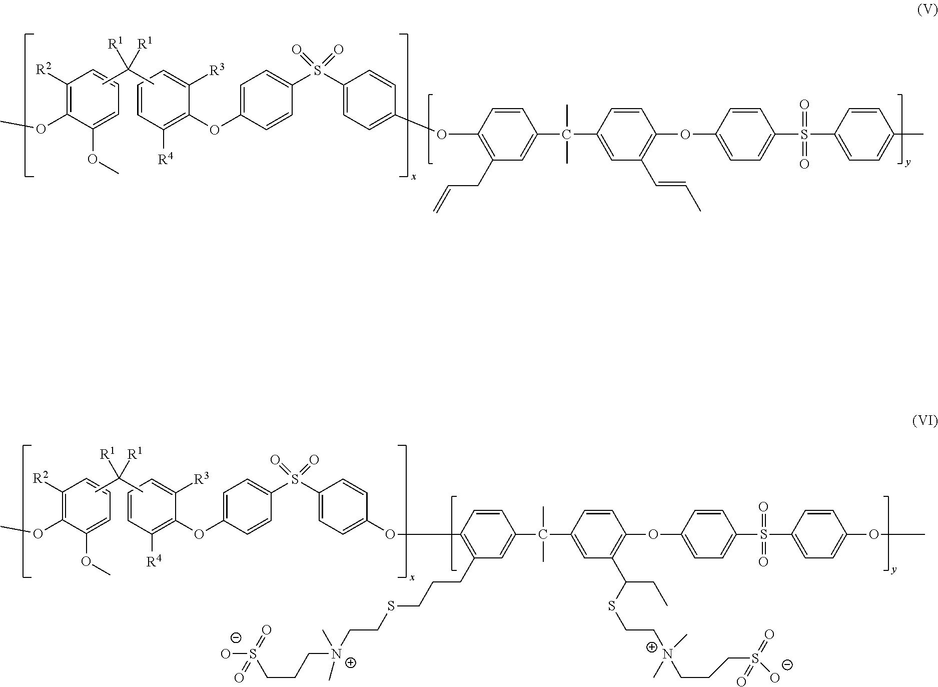
wherein x+y=1, 0<x≤1, and where x and y represent the molar fractions of the respective chemical units,
wherein R¹ is either H or methyl group; and R², R³, and R⁴ are each individually selected from an H or a methoxy group,
(iii) a BP-based PSf, and
(iv) a hydrophilic polymer.

13. The composition according to claim 11 further comprising one or more additives selected from the group consisting of tackifiers, plasticizers, viscosity modifiers, photoluminescent agent, anti-counterfeit and UV-reactive additives, dyes/pigments, anti-static materials, surfactants, and lubricants.

14. A membrane comprising the composition of according to claim 11.

15. An article comprising the membrane of claim 14.

16. The article of claim 15, wherein the article is a filtering apparatus.

17. The filtering apparatus of claim 16, wherein the filtering apparatus comprises a reverse osmosis apparatus, a dialysis apparatus, a nanofiltration apparatus, an ultrafiltration apparatus, or a microfiltration apparatus.

18. The filtering apparatus according to claim 17, wherein the membrane is configured to operate in a dead-end filtration mode, a cross-flow filtration mode, or a hollow fiber filtration mode.

19. The filtering apparatus of claim 17, wherein the membrane has a homogeneous pore size in the range from 0.5 nm to 10 μm, and is selected from the group consisting of:
(i) a nanofiltration membrane with a homogeneous pore size in the range of 0.5 to 10 nm;
(ii) a nanofiltration membrane with a homogeneous pore size in the range of 10 to 100 nm;
(iii) an ultrafiltration membrane with a homogeneous pore size in the range of 100 nm to 1 μm; and
(iv) a microfiltration membrane with a homogeneous pore size in the range of 1 to 10 μm.

20. The filtering apparatus according to claim 17, wherein the membrane is a reverse osmosis membrane having no pores or having pores with a size in the range of 0.2-0.5 nm.

21. A method of purifying water, the method comprising a step of filtering untreated water from a water source through the membrane according to claim 14.

22. The method of claim 21, wherein the method is applied for water reclamation, wastewater treatment, or water purification.

23. A membrane electrode assembly, comprising:
an anode;
a cathode; and
a proton exchange membrane positioned between the anode and the cathode, wherein the proton exchange membrane and at least one of the anode and the cathode comprises the bio-based polysulfone according to claim 1 modified with an anionic moiety to enable proton exchange.
